(19) United States
(12) Patent Application Publication
(10) Pub. No.: US 2024/0382056 A1
(43) Pub. Date: Nov. 21, 2024

(54) AIR TREATMENT UNIT

(71) Applicant: Omachron Intellectual Property Inc., Hampton (CA)

(72) Inventor: Wayne Ernest Conrad, Hampton (CA)

(21) Appl. No.: 18/318,307

(22) Filed: May 16, 2023

(51) Int. Cl. A47L 9/14; A47L 9/00; A47L 9/16; A47L 9/24; A47L 9/28; B01D 45/08; B01D 45/16; B01D 45/18; B01D 50/20; B65F 1/00

(52) U.S. Cl. CPC A47L 9/149; A47L 9/0063; A47L 9/1418; A47L 9/1683; A47L 9/248; A47L 9/2873; B01D 45/08; B01D 45/16; B01D 45/18; B01D 50/20; B65F 1/002; A47L 2201/022; A47L 2201/024

(57) ABSTRACT

A surface cleaning apparatus including an air treatment unit, a refuse unit, and a flexible hose. The air treatment unit includes an air flow path from a dirty air inlet to a clean air outlet and an air treatment member comprising an air treatment chamber and a dirt collection region having an emptying door which is operable between a closed position and an open position. The flexible hose is removably connectable to the dirty air inlet. The air treatment unit is operable in a first operating mode in which the air treatment member is in air flow communication with the dirty air inlet and the emptying door is closed. The air treatment unit is operable in a second operating mode in which air flow through the air treatment member is terminated and the emptying door is open whereby dirt is transferable to a refuse container of the refuse unit.

### FIELD

This disclosure relates generally to air treatment units, and more particularly to apparatus for removing dirt from an air flow stream.

### BACKGROUND OF THE INVENTION

The following is not an admission that anything discussed below is part of the prior art or part of the common general knowledge of a person skilled in the art.

Various types of air treatment members are known, including cyclones, momentum separators, and filters. Various types of air treatment units incorporating air treatment members are known, including various types of surface cleaning apparatus such as upright surface cleaning apparatus, canister surface cleaning apparatus, stick surface cleaning apparatus, central vacuum systems, and hand carriable surface cleaning apparatus such as hand vacuum cleaners.

### SUMMARY OF THE INVENTION

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

An apparatus comprises a garbage receptacle, such as a garbage can, which has an openable or removable lid. The apparatus is operable as a docking station when the lid is positioned to close the garbage receptacle. The lid comprises part of the air flow path of the docking station and may comprise part of an air treatment member. Optionally, the lid comprises an air treatment member and dirt, which is separated by the air treatment member, is received by the garbage receptacle while the apparatus is in use to empty a surface cleaning apparatus while the surface cleaning apparatus is docked at the apparatus and the apparatus is operated to empty a dirt collection region of the surface cleaning apparatus. Alternately, the lid may comprise an air treatment member and dirt, which is separated by the air treatment member, is received by the garbage receptacle after the apparatus has been used to empty a surface cleaning apparatus.

The lid may be or comprise an air treatment unit and the garbage receptacle may be or comprise a refuse unit.

An air treatment unit is configured to remove dirt from an air flow stream passing through an air flow path that extends through the air treatment unit. To remove dirt, the air treatment unit includes at least one air treatment member (e.g., one or more cyclones and/or one or more momentum separators). Each air treatment member includes a dirt collection region (e.g., in an air treatment chamber or in a separate dirt collection chamber that is exterior to an air treatment chamber) to receive dirt separated from the air flow stream.

The refuse unit is arranged to receive dirt from the dirt collection region(s) of the air treatment unit. In some embodiments, the refuse unit and the air treatment unit are secured together (e.g., removably) with the refuse unit below the air treatment unit, and a door of the air treatment unit is openable to dump dirt from the dirt collection region(s) into the refuse unit. The refuse unit may have a storage volume that is larger (e.g., 3, 5, 10, 15 or more times larger) than the storage volume of the dirt collection region(s) of the air treatment unit. Accordingly, the apparatus (the combined refuse unit and air treatment unit) may be operable to empty a surface cleaning apparatus that is docked at the apparatus 3, 5, 10, 15 or more times before the refuse unit requires emptying.

The air treatment unit and the refuse unit may together form a cleaning assembly that may be used to clean a surface. For example, a cleaning tool or hose may be mounted on an air inlet of the assembly to enable the assembly to be used as a surface cleaning apparatus.

The refuse unit may be isolated from an active (i.e., under positive or negative air pressure) air treatment path, allowing the refuse unit or a container thereof to be of various constructions that would not be suitable (e.g., flexible, collapsible containers such as a plastic or paper bag) if the refuse unit was exposed to positive or negative air pressure. For example, the refuse unit may include a flexible-walled refuse container such as a garbage bag. The refuse container may be supported by a support structure, such as a garbage bin or a frame with a set of legs. The support structure may hold the air treatment unit above a support surface such as a floor or other surface so that the refuse container may be arranged under the air treatment unit, such as to allow dirt to be transferred by gravity from the air treatment unit to the refuse container when a door of the air treatment member is opened. In some aspects, the cleaning assembly includes a dirt mover, including a mechanical member such as a piston to move dirt out of a dirt collection region and into the refuse container, optionally examples in which a dirt mover are included do not need the reuse container below the dirt collection region.

Optionally, the refuse container is a porous container (e.g., a paper or cloth bag). The porous container may form a separation stage, and the air flow path may extend through the porous container. The porous container may be used to remove dirt (e.g., course dirt) from the air flow path. The air flow path may subsequently extend through one or more further air treatment members to remove dirt (e.g., fine dirt). The subsequent air treatment member or members may be emptiable into the porous container.

The cleaning assembly may include a system for reducing dirt release when the refuse container is removed for disposal. The system for reducing dirt release may be included in examples in which the refuse container is a porous container. The system may be a dampening system, including a liquid reservoir and one or more nozzles to direct liquid on or in the refuse container. Dampening the refuse container and/or the contents thereof may reduce dirt release from the refuse container. The refuse container may be formed of a material that expands when dampened, and dampening the refuse container may close or partially close pores of a porous refuse container to reduce dirt release (e.g., reduce the release of fine dirt that may otherwise pass through the pores).

The refuse unit may be a variable-capacity refuse unit. The refuse unit may be configured as a small refuse unit to collect a small amount of dirt and be reconfigurable (e.g., expandable) to a larger configuration (volume) to collect a larger amount of dirt. For example, the refuse unit may be expanded during a dirt collection operation as the amount of dirt to be contained increases or it may be increased by a user if a larger amount of dirt is to be collected. The refuse unit may include an expandable support structure and/or an expandable refuse container.

Optionally, the air treatment unit includes an air moving member (e.g., a suction motor) and/or a hose or conduit at the inlet end of the air treatment path. Accordingly, the air treatment member may be used as a surface cleaning apparatus as well as a docking station for another surface cleaning apparatus (e.g., a robot vacuum or a hand vacuum).

Optionally, the air treatment unit is used with an air moving member of the docked surface cleaning apparatus (e.g., a hand vac) so as to enable the apparatus to evacuate the docked surface cleaning apparatus and/or to allow a user to use the air treatment unit as, or as part of, a surface cleaning apparatus.

In accordance with an aspect of this disclosure, which may be used alone or in combination with any one or more other aspects, an air treatment unit is provided as an openable or removeable lid for a garbage receptacle (e.g., a rigid-walled garbage can and/or a flexible bag). The air treatment unit includes an air treatment member with a dirt collection region. The dirt collection region is selectively openable into the garbage receptacle. The garbage receptacle is selectively fluidically isolated from the air treatment member. Accordingly, the air treatment member may be under positive or negative air pressure (i.e., relative to ambient or atmospheric pressure, e.g., negative air pressure upstream from a suction motor) without the garbage receptacle being under positive or negative air pressure. The garbage receptacle provides a large capacity for dirt without requiring that a large dirt collection region be built to withstand pressure. The garbage receptacle may be expandable, such as a flexible-walled container (e.g., a bag) with or without an expandable support (e.g., a telescoping frame).

In accordance with this aspect, there is provided a first surface cleaning apparatus comprising:
(a) an air treatment unit comprising:
   (i) a first air flow path from a first dirty air inlet to a clean air outlet; and,
   (ii) a first air treatment member comprising a first air treatment chamber and a first dirt collection region, the first collection region having an emptying door which is operable between a closed position and an open position,
(b) a refuse unit comprising a refuse container; and,
(c) a flexible hose that is removably connectable to the dirty air inlet,
wherein the air treatment unit is operable in a first operating mode in which the first air treatment member is in air flow communication with the dirty air inlet and the emptying door of the first dirt collection region is closed, and
wherein the air treatment unit is operable in a second operating mode in which air flow through the first air treatment member is terminated and the emptying door of the first dirt collection region is open whereby dirt is transferable to the refuse container.

In accordance with this aspect, there is also provided an apparatus comprising:
(a) a surface cleaning apparatus comprising:
   (i) a first air flow path from a first dirty air inlet to a clean air outlet; and,
   (ii) a first air treatment member comprising a first air treatment chamber and a first dirt collection region, the first dirt collection region having an emptying door which is operable between a closed position and an open position; and,
(b) a refuse unit comprising a refuse container,
wherein the surface cleaning apparatus is operable in a first surface cleaning operating mode in which the emptying door of the first dirt collection region is closed, and the surface cleaning apparatus is used to clean a surface whereby dirt is collected in the first dirt collection region, and
wherein the air treatment unit is operable in an emptying mode in which the surface cleaning apparatus is positioned on the refuse unit and closes an open end of the refuse unit, air flow through the first air treatment member is terminated and the emptying door of the first dirt collection region is open whereby dirt is transferable to the refuse container while the refuse container is at atmospheric pressure.

In accordance with another aspect of this disclosure, which may be used alone or in combination with any one or more other aspects, an air treatment unit includes a plurality of dirt collection regions in parallel, and each can be selectively coupled in air flow communication with the dirty air inlet. Accordingly, when a dirt collection region is uncoupled from air flow communication with the dirty air inlet, the dirt collection region may be emptied into a refuse unit or garbage receptacle while the remaining dirt collection region(s) continue to collect dirt. The air treatment unit may operate continuously while emptying dirt into the refuse unit, without exposing the refuse unit to positive or negative air pressure (i.e., relative to ambient or atmospheric pressure).

In accordance with this aspect, there is provided an assembly comprising:
(a) an air flow path from a dirty air inlet to a clean air outlet;
(b) a first air treatment member which is selectively connectable in air flow communication with the dirty air inlet, the first air treatment member comprising a first air treatment chamber and a first dirt collection region, the first collection region having an emptying door which is operable between a closed position and an open position; and,
(c) a second air treatment member which is selectively connectable in air flow communication with the dirty air inlet, the second air treatment member comprising a second air treatment chamber and a second dirt collection region, the second collection region having an emptying door which is operable between a closed position and an open position,
wherein the assembly is operable in a first operating mode in which the first air treatment member is in air flow communication with the dirty air inlet, the emptying door of the first dirt collection region is closed, the second air treatment member is isolated from air flow communication with the dirty air inlet and the emptying door of the second dirt collection region is openable whereby dirt is emptied from the second dirt collection region, and
wherein the assembly is operable in a second operating mode in which the second air treatment member is in air flow communication with the dirty air inlet, the emptying door of the second dirt collection region is closed, the first air treatment member is isolated from air flow communication with the dirty air inlet and the emptying door of the first dirt collection region is openable whereby dirt is emptied from the first dirt collection region.

In accordance with another aspect of this disclosure, which may be used alone or in combination with any one or more other aspects, a docking station for a surface cleaning apparatus is provided wherein the dirt collection region of the docking station cannot be opened during an evacuation operation, i.e. when the docking station is in use to empty a surface cleaning apparatus.

In accordance with this aspect, there is provided a docking station comprising:
(a) an openable dirt collection region which, during an evacuation operation of the docking station, receives dirt that is transferred from a surface cleaning apparatus,
(b) a lock having a locked position in which the dirt collection region is secured in a closed position, and an unlocked position in which the dirt collection region is openable,
wherein, during the evacuation operation, the lock is inhibited from moving to the unlocked position.

In accordance with this aspect, there is also provided an apparatus comprising:
(a) an air flow path extending from a dirty air inlet to a clean air outlet with a suction motor positioned in the air flow path;
(b) an openable dirt collection region into which dirt is pneumatically transferred when the suction motor is actuated,
(c) a lock having a locked position in which the dirt collection region is secured in a closed position, and an unlocked position in which the dirt collection region is openable,
wherein, during operation of the suction motor, the lock is inhibited from moving to the unlocked position.

In accordance with another aspect of this disclosure, which may be used alone or in combination with any one or more other aspects, a lid for a refuse container is operable as a surface cleaning apparatus or includes operable components of a surface cleaning apparatus. For example, the lid of a refuse container may include an air treatment member including a dirt collection region and a motor and fan assembly. Accordingly, the lid may be removed from the refuse container, optionally with a cleaning tool and/or hose attached to a dirty air inlet of the lid, and used as s surface cleaning apparatus. Dirt collected in the dirt collection region of the lid may be emptied into the refuse container, e.g., when or after the lid is replaced on the refuse container.

In accordance with this aspect, there is provided an apparatus comprising:
(a) an air flow path from a dirty air inlet to a clean air outlet; and,
(b) a first air treatment member comprising a first air treatment chamber and a first dirt collection region, the first dirt collection region having an emptying door which is operable between a closed position and an open position,
wherein the apparatus is operable in a first operating mode in which the first air treatment member is in air flow communication with the dirty air inlet and the emptying door of the first dirt collection region is closed, and
wherein the apparatus is operable in a second operating mode in which air flow through the first air treatment member is terminated and the emptying door of the first dirt collection region is open whereby dirt is transferable to a refuse container.

In accordance with another aspect of this disclosure, which may be used alone or in combination with any one or more other aspects, an apparatus comprises a refuse unit and an air treatment unit. The refuse unit includes a porous dirt collection container which is upstream of a second air treatment stage (e.g., a second air treatment chamber such as a cyclone or non-cyclonic momentum separator). Accordingly, during operation, air flowing through the porous dirt collection chamber may hold open, or assist in holding open, the air flow therethrough.

In accordance with this aspect, there is provided an apparatus comprising:
(a) an air flow path from a dirty air inlet to a clean air outlet;
(b) a refuse container positioned in the air flow path wherein at least a portion of the refuse container is porous; and,
(c) a second stage air treatment chamber downstream of the refuse container and upstream of the clean air outlet,
wherein, in operation, air enters the dirty air inlet and passes through the refuse container to the second air treatment chamber.

In accordance with this aspect, there is also provided an apparatus comprising:
(a) an air flow path from a dirty air inlet to a clean air outlet;
(b) a refuse container positioned in the air flow path wherein at least a portion of the refuse container is porous; and,
(c) a second air treatment stage downstream of the refuse container and upstream of the clean air outlet, wherein dirt collected in the second air treatment stage is emptied into the refuse container,
wherein, in operation, air enters the dirty air inlet and passes through the refuse container to the second air treatment stage.

In accordance with another aspect of this disclosure, which may be used alone or in combination with any one or more other aspects, a dirt collection region of a docking station of a refuse container that is sued with a lid comprising an air treatment unit, has a variable capacity.

In accordance with this aspect, there is provide an apparatus comprising:
(a) a surface cleaning apparatus comprising:
   (i) an air flow path from a dirty air inlet to a clean air outlet; and,
   (ii) an air treatment member comprising an air treatment chamber and a dirt collection region; and,
(b) a refuse unit comprising a refuse container, wherein the refuse unit is adjustable whereby a volume of the refuse container is variable,
wherein the surface cleaning apparatus is operable in a surface cleaning operating mode in which the surface cleaning apparatus is used to clean a surface whereby dirt is collected in the dirt collection region, and
wherein the air treatment unit is operable in an emptying mode in which the surface cleaning apparatus is docked with the refuse unit and dirt is transferred to the refuse container.

It will be appreciated by a person skilled in the art that an apparatus or method disclosed herein may embody any one or more of the features contained herein and that the features may be used in any particular combination or sub-combination.

These and other aspects and features of various embodiments will be described in greater detail below.

### BRIEF DESCRIPTION OF DRAWINGS

For a better understanding of the described embodiments and to show more clearly how they may be carried into effect, reference will now be made, by way of example, to the accompanying drawings in which:

FIG. 1 is a top perspective view of a first exemplary air treatment unit;

FIG. 2 is a bottom perspective view of the first exemplary air treatment unit of FIG. 1;

FIG. 3 is a top horizontal cross sectional perspective view of the unit of FIG. 1;

FIG. 4 is a first side vertical cross sectional perspective view of the unit of FIG. 1;

FIG. 5 is a second side vertical cross sectional perspective view of the unit of FIG. 1;

FIG. 6 is an end vertical cross sectional perspective view of the unit of FIG. 1;

FIG. 7 is the second side vertical cross sectional perspective view of FIG. 5 with a dumping door open;

FIG. 8 is the first side vertical cross sectional perspective view of FIG. 4 with the dumping door open;

FIG. 9 is a top perspective view of another exemplary air treatment unit positioned above a refuse unit;

FIG. 10 is a bottom perspective view of the air treatment unit of FIG. 9;

FIG. 11 is a top perspective view of FIG. 9 with the air treatment unit pivoted to the open position;

FIG. 12 is a first side cross sectional view of an exemplary cleaning assembly, which comprises an air treatment unit positioned above a refuse unit;

FIG. 13 is a second side cross sectional view of the exemplary cleaning assembly of FIG. 12;

FIG. 14A is a first side cross sectional view of another exemplary cleaning assembly;

FIG. 14B is a second side cross sectional view of the exemplary cleaning assembly of FIG. 14A; with an expandable refuse container in an expanded configuration;

FIG. 14C is a first side cross sectional view of another exemplary cleaning assembly;

FIG. 14D is a second side cross sectional view of the exemplary cleaning assembly of FIG. 14C with an expandable refuse container in an expanded configuration;

FIG. 14E is a first side cross sectional view of another exemplary cleaning assembly;

FIG. 14F is a second side cross sectional view of the exemplary cleaning assembly of FIG. 14E with an expandable refuse container in an expanded configuration;

FIG. 15 is a perspective vertical cross sectional view of another exemplary air treatment unit;

FIG. 16 is a perspective view of the unit of FIG. 15;

FIG. 17 is a perspective view of another exemplary air treatment unit;

FIG. 18A is a first side vertical cross sectional view of another exemplary cleaning assembly;

FIG. 18B is a second vertical side cross sectional view of the exemplary cleaning assembly of FIG. 18A;

FIG. 19 is perspective horizontal cross sectional view of another exemplary air treatment unit;

FIG. 20 is a side cross sectional view of a cleaning assembly which may be used in the air treatment unit of FIG. 19; and,

FIG. 21 is a schematic diagram of another exemplary air treatment unit.

The drawings included herewith are for illustrating various examples of articles, methods, and apparatuses of the teaching of the present specification and are not intended to limit the scope of what is taught in any way.

### DETAILED DESCRIPTION OF THE INVENTION

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. None of the terms “coupled”, “connected”, “attached”, and “fastened” distinguish the manner in which two or more parts are joined together.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

### Air Treatment Unit

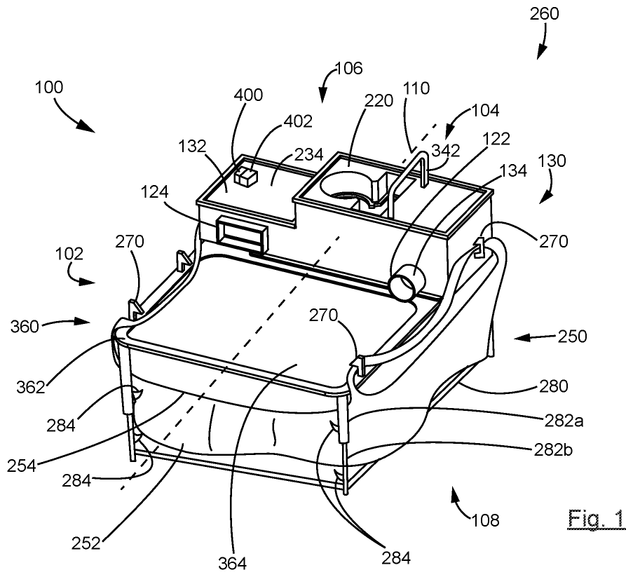

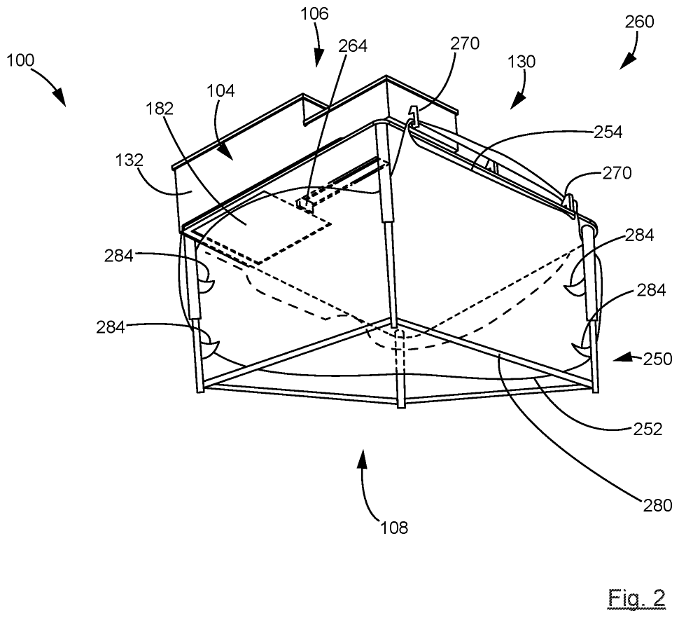

Referring to FIGS. 1 and 2, an exemplary embodiment of an air treatment unit is shown generally as 100. As exemplified, the air treatment unit 100 has a front end 102, a rear end 104, an upper end or top 106 and a lower end or bottom 108 with a longitudinal axis 110 that extends between the front and the rear ends 102, 104.

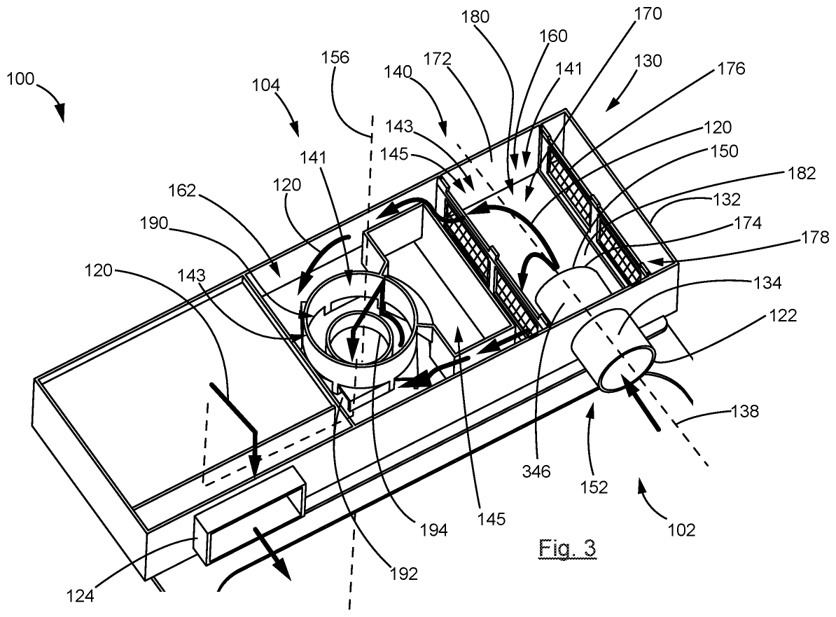

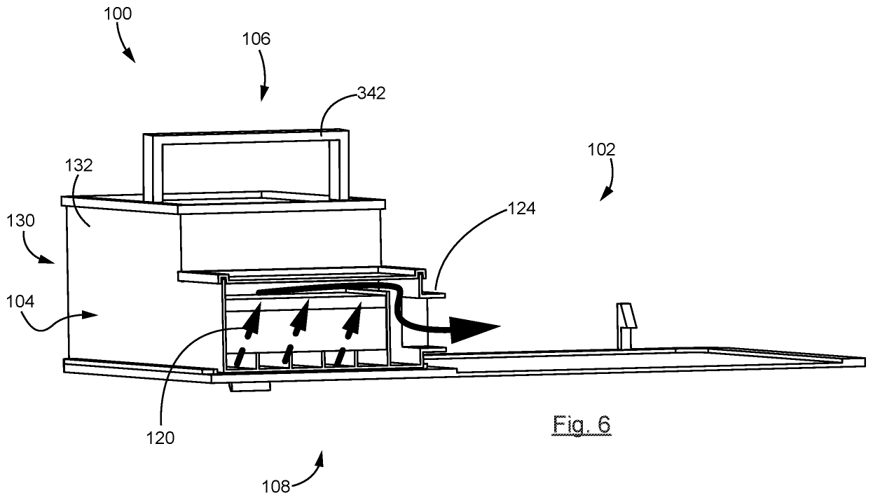

As exemplified in FIGS. 3 to 6, an air flow path 120 extends from a dirty air inlet 122 to a clean air outlet 124, and extends through an air treatment assembly 140. In the exemplary embodiment, the dirty air inlet 122 is provided at the front end 102. As exemplified in FIG. 1, the clean air outlet 124 may be provided at the same end as the dirty air inlet 122. In the exemplary embodiment, the clean air outlet 124 is provided at the front end 102. It will be appreciated that the dirty air inlet 122 and/or the clean air outlet 124 may be provided at different locations and/or be of different configurations.

The air treatment unit 100 includes a main body 130 comprising a housing 132. The air treatment assembly 140 is within the housing 132. It will be appreciated that the housing 132 of the air treatment unit 100 may be in other configurations, shapes, and/or positions in other examples.

The dirty air inlet 122 of the air treatment unit 100 is the inlet end of an inlet conduit or passage 134. The inlet conduit or passage 134 has a longitudinally extending axis 138 (FIG. 3). The conduit 134 extends between the dirty air inlet 122 and an outlet port 150 (FIG. 3) of the inlet conduit 134. The outlet port 150 may be located at the inlet port of the air treatment assembly 140.

Optionally, the inlet end 122 of the conduit 134 can be used as a nozzle 152 to directly clean a surface. Alternatively, or in addition to functioning as a nozzle 152, inlet conduit 134 may be connectable or directly connectable to the downstream end of any suitable accessory tool such as a hose, rigid air flow conduit (e.g., an above floor cleaning wand), a crevice tool, a mini brush, and the like. Accordingly, as discussed subsequently herein, according to one aspect, the air treatment unit 100 or the main body 130 disclosed herein may be part of a surface cleaning apparatus or may itself be used as a surface cleaning apparatus, such as a hand vacuum cleaner or as a stick vac comprising a floor cleaning head, a rigid air flow conduit that is moveably mounted to the floor cleaning head at an inlet end of the rigid air flow conduit, and the air treatment unit 100 or the main body 130 disclosed herein.

The inlet conduit or passage 134 may be, as exemplified in FIGS. 3 to 6, a generally linear conduit or passage 134. The conduit or passage 134 may extend rearwardly from the inlet end 122, and may extend generally parallel to the longitudinal axis 110 and perpendicular to the cyclone axis 156. The axis 138 of the conduit 134 may extend between the rear end 104 and the front end 102 of the air treatment unit 100, and may extend along a longest dimension of the conduit 134. As exemplified, the inlet conduit 134 is part of the main body 130 and extends forwardly therefrom.

The air treatment assembly 140 is configured to remove particles of dirt and other debris from the airflow and/or otherwise treat the airflow. Any air treatment member or members known in the art may be used as part of the assembly 140. For example, the surface cleaning apparatus may use one or more stages, each of which may comprise one or more cyclones, non-cyclonic momentum separators, bags, screens, physical filter media (e.g., foam, felt, HEPA) or the like. The air treatment assembly 140 may comprise one stage or a plurality of stages in series. Each stage may include one treatment member (e.g., a cyclone, filter bag, or momentum separator) or a plurality of treatment members in parallel (e.g., a plurality of cyclones in parallel).

As exemplified in FIG. 3, each treatment member 141 may include an air treatment region 143 (which may be referred to as an air treatment chamber) and a dirt collection region 145. The dirt collection region 145 is in communication with the treatment region 143 to receive dirt separated in the treatment region 143. The dirt collection region 145 may be a region of a common chamber shared with the treatment region 143 (e.g., the air treatment region 143 and the dirt collection region 145 may be a single contiguous chamber and, in operation, the dirt collection region may be a lower portion of an air treatment chamber), or a separate chamber (i.e., a dirt collection chamber 147) that is external to the air treatment region 143 (e.g., an air treatment chamber). If a dirt collection region 145 shares a common chamber with the dirt treatment region 143, the dirt collection region 145 and the air treatment region 143 may be separated by, e.g., one or more baffles.

As exemplified in FIG. 3, the air treatment assembly 140 may be a multi-stage air treatment assembly. Optionally, as exemplified, the first stage may be a non-cyclonic momentum separator and the second stage may be one or more cyclones in parallel. Accordingly, the air flow path 120 extends through the plurality of air treatment members in series. The exemplary air flow path 120 extends through a first-stage air treatment member 160 (which is exemplified as a non-cyclonic momentum separator) and a second-stage air treatment member 162 (which is exemplified as a cyclone). A pre-motor filter may also be provided. It will be appreciated that the air treatment assembly 140 may alternatively be a single-stage assembly (such as a single cyclonic stage, which may comprise one or more cyclones in parallel, or a single non-cyclonic momentum separator chamber) or include more than two stages in series. For example, the air treatment assembly 140 may include a plurality of cyclonic stages, each of which have one cyclone or a plurality of cyclones in parallel.

As exemplified in FIG. 3, the first-stage air treatment member 160 is a non-cyclonic momentum separator comprising a momentum separator chamber 170. The non-cyclonic momentum separator comprises a chamber in which the velocity and/or direction of air flow is changed to enable entrained particulate matter to be disentrained from the air stream. The disentrained particulate matter may collect in the chamber.

The momentum separator chamber 170 includes a dirt collection region 180. It will be understood that the momentum separator chamber 170 and the dirt collection region 180 may be of any configuration suitable for separating dirt from an air stream and collecting the separated dirt, respectively. As exemplified, the dirt collection region 180 may be a portion of the momentum separator chamber 170. It will be appreciated that alternatively, the dirt collection region 180 may be a separate dirt collection chamber.

As exemplified, the momentum separator chamber 170 has a non-porous wall 172 opposite the inlet 174 of the momentum separator chamber 170. The non-porous wall 172 may function as an impact wall to slow down or redirect air entering the chamber. A screen 176 comprises the outlet 178 of the momentum separator chamber. It will be appreciated that any number of porous wall sections or porous walls (e.g., screens) may be provided. The dirt collection region 180 of the momentum separator is against an openable outer wall 182 of the housing 130, as discussed subsequently. The dirt collection region 180 may be against a lower wall of the housing 130, as exemplified.

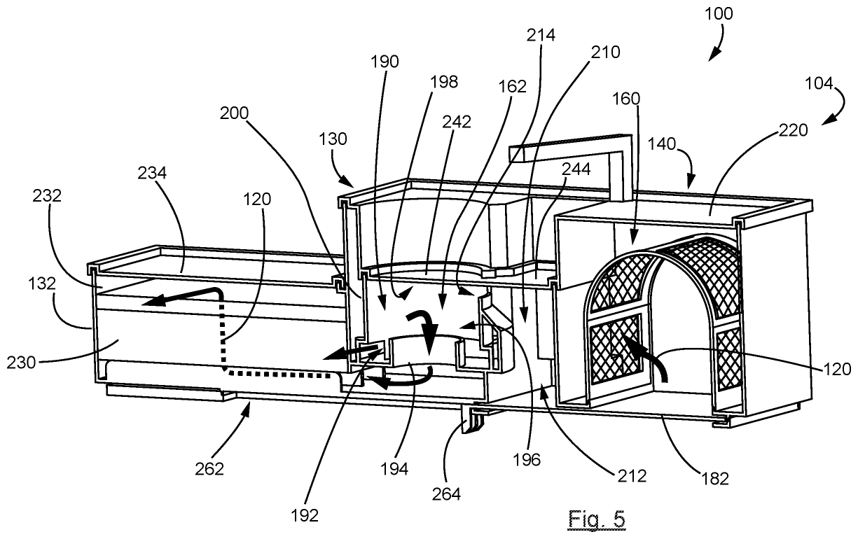

As exemplified in FIG. 3, the second-stage air treatment member 162 is a cyclonic stage with a single cyclone chamber 190. It will be appreciated that the cyclonic stage may alternatively have a plurality of cyclone chambers in parallel, each of which may have one or more associated dirt collection chambers. As exemplified in FIG. 5, the cyclone chamber 190 includes a cyclone air inlet 192, a cyclone air outlet 194, a cyclone bottom end 196, a cyclone top end 198 axially spaced from and opposed to the cyclone bottom end 196, and a sidewall 200 between the top and bottom ends 196, 198. The cyclone chamber 190 may have the air inlet 192 and the air outlet 194 at the same end as exemplified in FIGS. 3 to 6, or may be a uniflow cyclone (with the air inlet and the air outlet at axially opposed ends).

The cyclone chamber 190 has a centrally-located cyclone axis of rotation 156. The exemplary cyclone axis of rotation 156 is a generally vertical axis extending between the top end 106 and the bottom end 108. The exemplary cyclone axis of rotation 156 is oriented generally perpendicular to the inlet conduit axis 138.

The exemplary cyclone separator 162 includes a dirt collection region 210. It will be understood that the cyclone chamber 190 and the dirt collection region 210 may be of any configuration suitable for separating dirt from an air stream and collecting the separated dirt, respectively. As exemplified, the dirt collection region 210 may be in a separate dirt collection chamber 212. The dirt collection chamber 212 communicates with the cyclone chamber 190 via a gap or dirt outlet 214. The dirt outlet 214 may be one or more openings in a wall separating the air treatment chamber 190 and the dirt collection chamber 212. The opening 214 has an outer perimeter defined by the wall in which the dirt outlet is provided or the walls which abut the dirt outlet. Any dirt outlet may be used. The exemplary dirt outlet 214 is arranged such that dirt and debris—entrained in air flow inside of the cyclone chamber 190—may be ejected (e.g., “spit-out”) through the gap and into the dirt collection chamber 212. The dirt outlet 214 may be a gap in the sidewall 200 of the cyclone chamber 190.

It will be appreciated that a cyclone separator may also or alternatively include the dirt collection region 210 that is in the cyclone chamber (e.g., a lower portion thereof).

As exemplified, the dirt collection region 210 of the cyclone separator 162 is against an openable outer wall 182 of the housing 130, as discussed subsequently. The dirt collection region 210 may be against a lower wall of the housing 130, as exemplified.

If the air treatment assembly 140 includes an air treatment chamber and a corresponding dirt collection chamber that is external to the air treatment chamber (e.g., cyclone chamber 190 and dirt collection chamber 212), then the air treatment chamber and the dirt collection chamber may be concurrently openable, such as by opening a wall or portion of each chamber, such as a top end or wall 220 of the air treatment assembly 140 (e.g., a top door), thereby enabling the air treatment chamber and the dirt collection chamber to be concurrently emptiable.

In some examples, during an opening or emptying operation, a wall or walls defining a first part of the perimeter of a dirt outlet between the air treatment chamber and the dirt collection chamber (e.g., dirt outlet 214) may be moved relative to a wall or walls defining a second part of the dirt outlet thereby opening the dirt outlet. The dirt outlet (e.g., dirt outlet 214) may be a gap between two or more separable plates or panels. For example, the dirt outlet 214 may be a gap between the sidewall 200 and the top or end wall or closure member 220 of the cyclone chamber 190. In some examples, the end wall 220 of the cyclone chamber 190 and the sidewall 200 may be moved apart (e.g., to open the cyclone chamber 190 and/or dirt collection chamber 212). Separating plates or panels that form the perimeter of the dirt outlet 214 may open up the dirt outlet (e.g., to allow bridging debris to be removed more easily from the dirt outlet 214).

As exemplified, the longitudinal axis 110 is perpendicular to the cyclone axis of rotation 156. The longitudinal axis 110 is parallel to the inlet axis 138. It will be apricated that the longitudinal axis 110 may alternatively be parallel to the cyclone axis 156 and/or perpendicular to the inlet axis 138. Preferably, when the upper end 106 of the air treatment unit 100 is positioned above the lower end 108, the cyclone axis 156 is oriented generally vertically and the longitudinal axis 110 is oriented generally horizontally. In other examples, however, the cyclone axis 156 may extend at any angle to the horizontal, or may extend generally horizontally. Accordingly, the cyclone chamber 190 may be oriented in any direction within the air treatment unit 100.

The air treatment unit 100 may include one or more filters in the air flow path. The filter(s) may be pre-motor and/or post-motor filters. As exemplified, the air treatment unit 100 may include a filter 230 downstream of the cyclonic cleaning stage 162 and upstream of the clean air outlet 124. The filter 230 may be formed from any suitable physical, porous filter media and may have any suitable shape. For example, the filter 230 may be or include one or more of a foam filter, felt filter, HEPA filter, other physical filter media, electrostatic filter, and the like.

The filter 230 may be provided in a filter housing 232. The filter housing 232 may be of any suitable construction. The filter housing 232 may be openable or accessible to allow the filter 230 to be cleaned and/or replaced. As exemplified, the filter housing 232 may include at least one openable outer wall or filter access door 234 of the housing such that the filter 230 is accessible when the filter access door 234 is open. The filter access door 234 may be joined to an air treatment access door that is openable for accessing an air treatment chamber (e.g., air treatment access door 242 for accessing cyclone chamber 190) and/or a dirt region access door that is openable for accessing a dirt collection region (e.g., dirt region access door 244 for accessing dirt chamber 212), or may be independent as exemplified in FIGS. 3 to 6.

In some embodiments, at least two of the filter access door 234, dirt region access door 244, and air treatment access door 242 may be part of a common door 220. As exemplified in FIGS. 3 to 6, the dirt region access door 244 and the air treatment access door 242 form a single common access door 220.

A door may be openable while still secured to the housing (e.g., pivotally secured to be pivotally or rotatably opened). Alternatively or additionally, a door may be removeable from the housing (i.e., fully separated from the housing, not e.g., pivotally connected when open). A door may open pivotally or be removeable in any suitable direction. For example, a door may be removeable upwardly or laterally. A door that is removable upwardly may be referred to as a lid. As exemplified, the common access door 220 is a lid on the housing 130.

### Separate Main Refuse Unit

In accordance with an aspect of this disclosure, a main refuse unit is provided that, during use of the air treatment unit 100, is pneumatically isolated from the air flow path 120 through the air treatment unit 100. This refuse unit may be used by itself or in combination with one or more of a refuse unit including a porous container, reducing dirt release during removal, a variable-capacity refuse unit, an on-board suction source, an on-board power supply, useable as a surface cleaning apparatus, useable as a docking station, useable to close off a refuse unit, dumping in using gravity, dumping using a dirt mover, accessible refuse unit while the air treatment unit is attached, status-dependent operation, and continuous operation pneumatically isolated from the refuse unit, which are set out herein.

As exemplified, the air treatment unit 100 may include one or more dirt collection regions (e.g., dirt collection regions 210, 180) that empty into a separate main refuse unit 250. During use of the air treatment unit 100 (e.g., as a docking station or as a surface cleaning apparatus as discussed subsequently), the main refuse unit 250 is pneumatically isolated from the air flow path. The main refuse unit 250 is pneumatically isolated from negative or positive air pressure (i.e., relative to ambient or atmospheric pressure) in the air flow path. Accordingly, the main refuse unit 250 does not need to be constructed to bear up under negative or positive air pressure in the air flow path. Therefore, the walls of the main refuse unit 250 may be thinner, they may be flexible and optionally they could merely be a frame that supports a bag, which may be a disposable bag (e.g., plastic or paper). Alternately, a bag could be inserted in the main refuse container 250. As the interior volume of the main refuse container 250 is isolated from air flow during use of the air treatment unit 100, the bag would not need to be secured in place to maintain its position as a result of air flow therethrough, which is the case with vacuum cleaners that use a bag.

As discussed subsequently, the refuse unit 250 may periodically receive dirt collected by the air treatment unit 100 (either during use of the air treatment unit 100, e.g., as a docking station and/or as a surface cleaning apparatus, or subsequent to the use thereof).

As exemplified in FIGS. 1 and 2, the main refuse unit 250 may periodically receive particulate matter (e.g., dirt) that is collected by the air treatment unit 100. Accordingly, for example, the main refuse unit 250 may be separated or isolated from the air flow path 120 by at least one moveable wall or door such that the main refuse unit 250 is selectively connectable with a dirt collection region of the air treatment unit 100. When the dirt collection region is in air flow communication with an active air flow path (i.e., an air flow path under positive or negative air pressure during use of the air treatment unit 100), the refuse unit may be pneumatically isolated from the dirt collection region. When the dirt collection region is not in air flow communication with an active air flow path (e.g., a suction motor is turned off so that air flow path is not under positive or negative air pressure, or the dirt collection region is pneumatically isolated from the active air flow path by, e.g., a moveable wall or door), the dirt collection region may be open or openable to the refuse unit to allow dirt to be transferred therebetween, e.g., mechanically and/or by gravity.

As exemplified, a cleaning assembly 260 includes the air treatment unit 100 and the refuse unit 250. The refuse unit 250 includes a refuse container 252 having an upper opening 254.

It will be appreciated that the refuse unit 250 may be of any shape that supports the air treatment unit 100 and is optionally configured, e.g., by feet or a flat base or bottom end 251, to be free standing on a floor when the air treatment unit 100 is positioned thereon. The refuse unit 250 may be a single container 252, e.g., a garbage can, that has an upper end on which the air treatment unit 100 may be provided. Optionally, a plurality of containers may be provided. The or each container 252 may have a single open interior volume or the interior may be subdivided into a plurality of open interior volumes.

The refuse unit 250 may be free standing during an emptying operation of the air treatment unit 100 in which dirt is emptied from the air treatment unit 100 into the refuse unit 250. The refuse unit 250 may support the air treatment unit 100 during an emptying operation of the air treatment unit 100.

It will be appreciated that, when the air treatment unit 100 is provided on the upper end of refuse container 250 with the opening 254 directed towards the air treatment unit 100, the dirt collection region(s) of the air treatment unit 100 may overlie or be partially or fully received in the refuse container 252 such that dirt may fall by gravity from an open dirt collection region of the air treatment unit 100 into the refuse container 250. Optionally, the perimeter of the air treatment unit 100 is the same as the refuse container 252. However, a portion of the air treatment unit 100 may be located external to the perimeter of the refuse container 252 provided that a path for dirt to travel from the air treatment unit 100 into the refuse container 252 is provided.

At least one dirt collection region of the air treatment unit 100 is openable such that, when the air treatment unit 100 is provided on the upper end of refuse container 250, dirt collected in a dirt collection region of the air treatment unit 100 can be emptied into the refuse unit 250 (e.g., into the refuse container 252). As exemplified, a dirt dumping door 182 of the air treatment unit 100 is openable.

The dumping door 182 may be at any location that enables dirt to be transferred to the refuse unit 250. Collected material may be transferred to the refuse unit 250 by gravity and/or a dirt mover as discussed subsequently. The dirt dumping door 182 may form an outer wall of the air treatment unit 100. The dirt dumping door 182 may form a wall of a dirt collection region. As exemplified, multiple dirt collection regions may be concurrently openable by opening a single door, for example, the dirt dumping door may extend across multiple chambers to form an openable wall of multiple chambers. It will be appreciated that each chamber may alternatively have an independent dirt dumping door. The exemplary dirt collection regions 180, 210 each abut the dirt door 182 and are opened by opening the dirt dumping door 182.

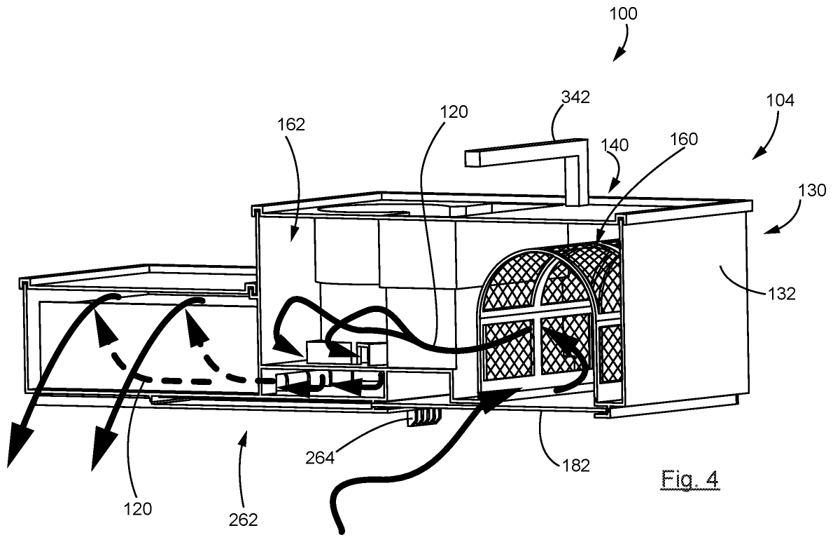

As exemplified in FIGS. 1 and 2, the dirt dumping door 182 may be at the bottom end 108 of the air treatment unit 100. The dirt dumping door 182 may be opened by sliding the dirt dumping door along another wall of the housing 130 or into a pocket in the housing or rotating the door downwardly to an open position. As exemplified, the dirt dumping door 182 may be slid into a pocket 262 of the housing 130. The door 182 is slid open generally horizontally when the upper end 106 of the unit 100 is over the lower end 108 (see FIG. 4 wherein the door 182 is in a closed position). It will be appreciated that the door 182 may alternatively or additionally be openable in another way, such as swinging open about a pivot hinge, or being separated from the housing 130 (e.g., lifted off).

The door may be opened manually or by using an electro-mechanical member (such as a solenoid or motor).

As exemplified, a manual tab 264 is provided, mechanically linked to the door 182 to allow a user to manually draw the door 182 open (e.g., slide the door 182 back into the pocket 262). Optionally, a user operable actuator, such as a tab 264) is provided at a location such that the door may be opened while the air treatment unit is mounted on the refuse unit, e.g., it may be provided on a side of the air treatment unit 100. It will be appreciated that the actuator may be a push button that is mechanically connected to a door lock, which unlocks the door when pushed. The door may open due to gravity or it may be biased open. The door may be closed by a user manually closing the door or by an electromechanically member that moves the door to a closed position upon receipt of a signal.

It will be appreciated that the actuator may be a push button that is electromechanically (e.g., a solenoid or motor) connected to the door to move the door between the open and closed position and/or to unlock and/or lock a door lock. Accordingly, a powered door actuator may be provided for opening the dirt dumping door 182 when directed by a user (e.g., when a user pushes a button on the air treatment unit 100) or automatically (e.g., when the dirt level sensor indicates that the dirt collection region is full).

The dirt dumping door 182 opens a dirt collection region to the refuse unit 250. Closing the dirt dumping door 182 pneumatically isolates the refuse unit 250 from the air flow path 120. Accordingly, the refuse unit 250 does not need to withstand the positive (downstream of a suction source) or negative (upstream of a suction source) air pressures in the air flow path.

As exemplified, the refuse unit 250 and/or the container 252 thereof may be removably mounted to the air treatment unit 100. Accordingly, the user may be able to choose to use the air treatment unit 100 without the refuse unit 250, e.g., as a vacuum cleaner to clean a surface as discussed subsequently. Alternately, or in addition, the user may be able to replace a first refuse unit or a first container thereof with a second refuse unit or a second container in the first refuse unit, such as by filling up the first refuse unit or the first container and then disposing of the first refuse unit or the first container.

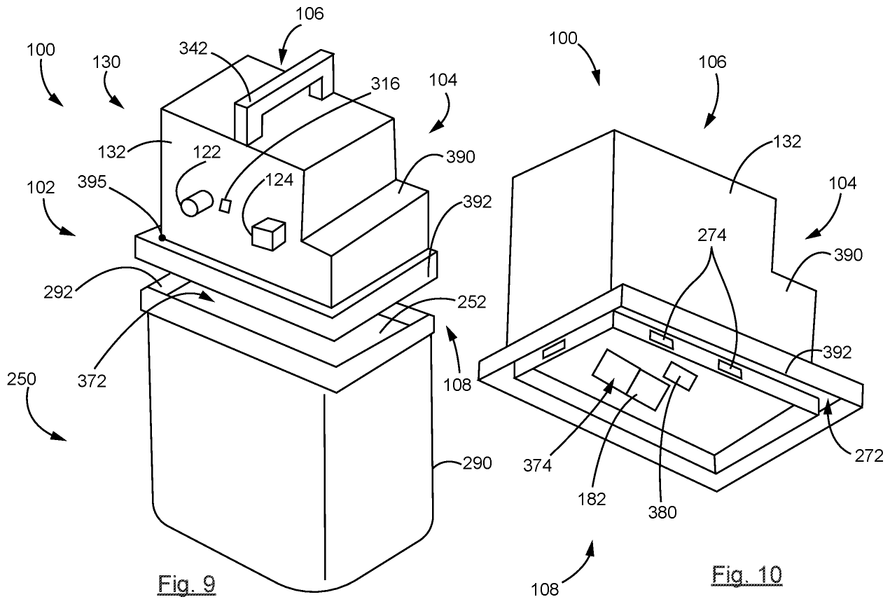

As exemplified in FIGS. 9 and 11, the air treatment unit 100 may form a lid for a refuse unit 250. It will be appreciated that refuse unit may be opened for emptying by removing (e.g. lifting as exemplified in FIG. 9) the air treatment unit 100 from the refuse unit 250 or pivoting the air treatment unit 100 to an open position (as exemplified in FIG. 11).

By the air treatment unit 100 closing off the opening 254, odors may be better contained in the refuse unit 250 and/or dust plumes exiting the refuse container 250 may be inhibited or reduced when dust is dumped from the air treatment unit 100 into the refuse unit 250.

As exemplified in FIG. 9, the refuse unit 250 is a rigid-sided garbage can, optionally lined with a flexible bag and the housing 130 of the air treatment unit 100 rests on an upper rim 292 of a garbage can 290. The air treatment member (e.g., the housing 130) therefore forms a lid covering the upper opening 254.

When used with a flexible refuse unit 250 or refuse container 252, such as a disposable bag, the perimeter of an opening of a bag may be stretched around the air treatment unit, or the perimeter of the opening of the bag may be otherwise secured to the air treatment unit such that the air treatment unit closes off the opening.

Optionally, the air treatment unit 100 and/or the refuse unit 250 may include fasteners for removably holding the refuse unit 250 and the air treatment unit 100 together. As exemplified in FIGS. 1 to 2, the air treatment unit 100 may include fasteners 270 in the form of hooks to which the refuse unit 250 may be hung. An advantage of this design is that, optionally, the air treatment unit 100 may be used to clean a surface with the refuse unit 250 attached, thereby providing a larger dirt collection volume.

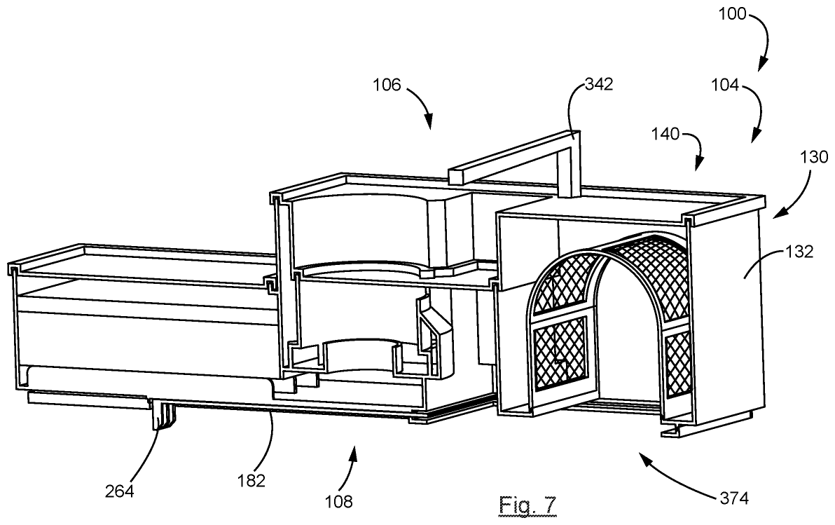

As exemplified in FIGS. 9 and 10, the air treatment unit 100 may include a fastener in the form of a groove 272 to rest on an upper lip of the refuse unit 250. The air treatment unit 100 may include, e.g., clips 274 in the groove 272 to hold the air treatment unit 100 and the refuse unit 250 together. As exemplified in FIG. 7, the refuse unit 250 may include a garbage bin or container. The garbage bin or container may include rigid walls and floor with an open top covered by the air treatment unit 100 as discussed herein.

### Use as a Surface Cleaning Apparatus

In accordance with an aspect of this disclosure, the air treatment unit 100 is useable as a surface cleaning apparatus. This aspect may be used by itself or in combination with one or more other aspect of this disclosure including the use of the air treatment unit as a docking station, providing the air treatment unit with an on-board power supply, emptying the air treatment unit using gravity and/or a dirt mover, accessing the refuse unit while the air treatment unit is attached, continuous operation of the air treatment unit while pneumatically isolated from the refuse unit, status-dependent operation, a variable-capacity dirt collection region, a refuse unit including a porous container and reducing dirt release during removal which are set out herein.

In accordance with an aspect of this disclosure, the air treatment unit 100 may be useable as a surface cleaning apparatus while attached to the refuse unit 250 or while removed therefrom. If the air treatment unit is used by itself (while removed from the refuse unit 250) as a surface cleaning apparatus, then the dirt collection region(s) of the air treatment unit 100 collect and store, e.g., particulate matter, which is collected while the air treatment unit 100 is used as a surface cleaning apparatus and subsequently deposited into the refuse unit 250 when the air treatment unit 100 is mounted to the refuse unit 250. In such a case, the particulate matter, which is collected while the air treatment unit 100 is used as a surface cleaning apparatus, may be automatically transferred to the refuse unit 250 as the air treatment unit 100 is mounted to the refuse unit 250 or immediately thereafter. For example, an actuator may send a signal to a solenoid or motor to open the dirt collection region(s) so that collected particulate matter may be transferred to the refuse unit. Alternately, a user may operate an actuator to manually open and close the dirt collection region(s) so that collected particulate matter may be transferred to the refuse unit. Any dirt transfer mechanism known in the art or disclosed herein may be used.

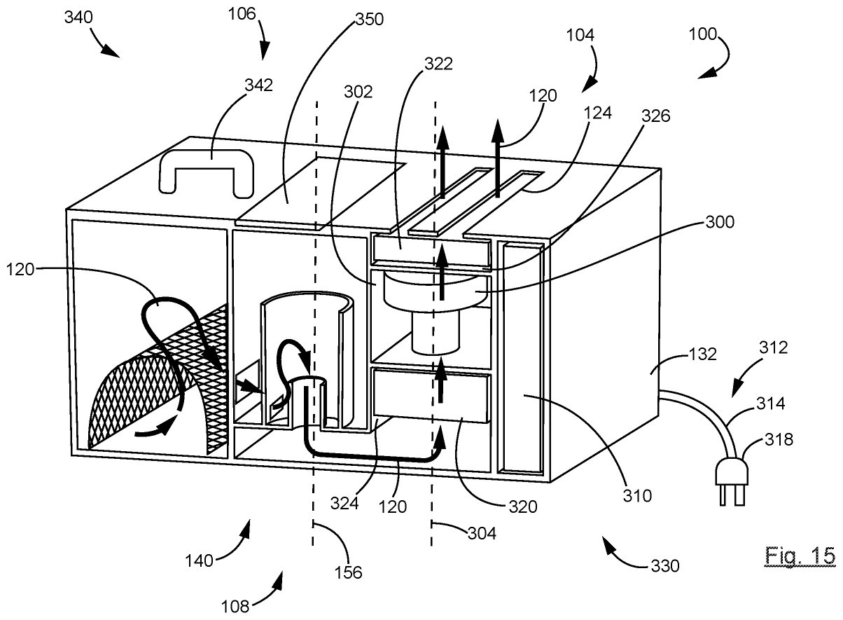

It will be appreciated that, if the air treatment unit is to be used as a surface cleaning apparatus, then, as exemplified in FIG. 15, the air treatment unit 100 will have an on-board air moving member 300.

As exemplified in FIG. 15, the air treatment unit 100 includes an air moving member 300, e.g., a motor and fan assembly. Any air moving member may be used. The air moving member 300 is operable to move air through the air flow path 120. As exemplified, the motor and fan assembly is operable to draw air through the air flow path from the air inlet 122 and drive air out through the clean air outlet 124. When the air moving member 300 is operating the air flow path is active. In other words, when the air moving member is operating to move air, the air flow path is under positive (downstream) and/or negative (upstream) air pressure.

As exemplified in FIG. 15, the air moving member 300 may be located within the housing 130 and may be contained within an air moving member housing (motor housing) 302. It will be appreciated that the air moving member housing 302 may form part of the outer surface of the main body housing 130 whereby an outlet grill may form part of the motor housing 302.

The air moving member 300 in the illustrated example is positioned downstream from the air treatment assembly 140, although it will be appreciated that the air moving member 300 may be positioned upstream of the air treatment assembly 140 (e.g., a dirty air motor) in alternative embodiments.

The air moving member 300 rotates about a central axis of rotation 304. Preferably, when the upper end 106 of the air treatment unit 100 is positioned above the lower end 106, e.g., in an orientation as exemplified in FIG. 15 in which the air treatment unit is operable to clean a floor, the motor axis of rotation 304 is oriented generally vertically and extends between the upper end 106 and the lower end 108. In other examples, however, the axis of rotation 304 may extend at any angle to the vertical, or it may extend horizontally. Accordingly, the air moving member 300 may be oriented in any direction within the air treatment unit 100. The axis of rotation 304 may be spaced (e.g., laterally spaced in a horizontal plane) from the cyclone axis 156 or it may be coaxial therewith. The axis of rotation 304 may be parallel to the cyclone axis 156 or it may extend at an angle thereto.

Optionally, to reduce the height of the air treatment unit 100 between the upper end 106 and the lower end 108 is reduced by positioning the air moving member 300 laterally from the air treatment member (chamber). In such a case, the air may travel laterally from the air treatment member and then vertically to the inlet of the air moving member 300 (e.g., a suction motor inlet) as exemplified in FIG. 15. Alternately, the inlet may face an outlet of the air treatment member, e.g., in the orientation of FIG. 15 the air treatment member may be a cyclone that has a horizontally oriented axis of rotation and the inlet may face the cyclone air outlet.

If a suction source 300 is provided, then the air treatment unit 100 may also include a pre-motor filter 320 and/or a post-motor filter 322. The pre-motor filter 320 may be provided in a premotor filter housing 324, and the post-motor filter 322 may be provided in a post-motor filter housing 326. One or both of the pre-motor filter housing 324 and the post motor-filter housing 326 may be openable (e.g., to replace the filter). In some examples, one or both of the pre-motor filter 320 and the post-motor filter 322 is omitted.

Power for the air moving member 300 is provided by a power supply 330, which may be an on-board power storage member 310, as described further subsequently, and/or a power coupling 312 to an external source. The power coupling 312 may be an electric cord 314 to a residential power supply system (e.g., to be plugged into a residential power outlet).

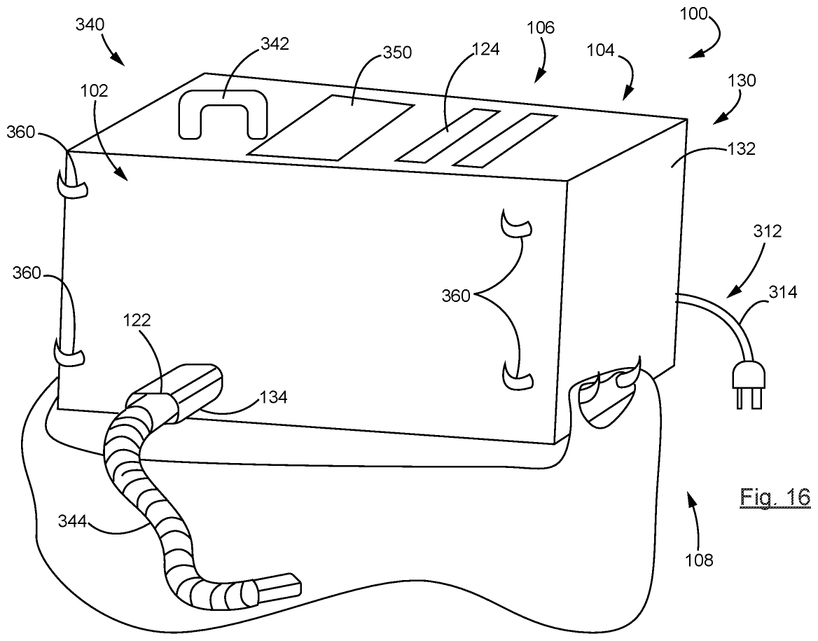

As exemplified in FIGS. 15 and 16, the surface cleaning apparatus 340 is a hand vacuum cleaner, which may also be referred to also as a “handvac” or “hand-held vacuum cleaner”. As used herein, a hand vacuum cleaner is a vacuum cleaner that can be operated to clean a surface generally one-handedly. That is, the entire weight of the vacuum may be held by the same one hand used to direct a dirty air inlet of the vacuum cleaner with respect to a surface to be cleaned. The surface cleaning apparatus 340 may include a handle 342. If the surface cleaning apparatus 340 is a hand vac, then the handle 342 and the clean air inlet 122 may be rigidly coupled to each other (directly or indirectly) so as to move as one while maintaining a constant orientation relative to each other. This is to be contrasted with canister and upright vacuum cleaners, whose weight is typically supported by a surface (e.g. a floor) during use. It will be appreciated that surface cleaning apparatus 340 may alternately be any surface cleaning apparatus, such as an upright surface cleaning apparatus, a stick vac, a canister surface cleaning apparatus, an extractor or the like. It will also be appreciated that the surface cleaning apparatus may use any configuration of the operating components and the airflow path exemplified herein.

It will be appreciated that the shape and configuration of the air treatment unit may be any that facilitates the use of the air treatment unit as a surface cleaning apparatus. Accordingly, the air flow path 120 through the air treatment chamber(s), filters and air moving member may be any layout that enables a particular shape and configuration of the air treatment unit 100.

It will be appreciated that the dirt air inlet 122 may be any dirt air inlet 122 known in the surface cleaning arts. For example, it may be an opening or port that is provided in a wall of the housing 130 or an inlet conduit 134 that extends outwardly therefrom (see for example FIG. 9). The dirt air inlet 122 may be useable itself as a nozzle to clean a surface. Alternately, or in addition, an accessory cleaning tool (e.g., a hose 344, crevice tool or the like) may removably attachable to the air treatment unit (e.g., to an inlet of an air inlet conduit 134).

As exemplified in FIGS. 15 and 16, the dirt air inlet 122 is the inlet of an air inlet conduit 134. As exemplified, the conduit 134 is a rigid-walled conduit extending out from the housing 130, which may be applied directly to a surface (e.g., curtains or a couch). Alternatively or additionally, a hose 344 may be removably attachable to the air treatment unit 100. As exemplified, the hose 344 may be removably securable to the conduit 134.

It will be appreciated that alternatively, the air treatment unit 100 may not include a conduit extending out from the main body housing 130, such as if the dirty air inlet is an opening in a housing wall that opens directly into an air treatment chamber or if the conduit 134 is an internal conduit that does not extend or project outwardly from the housing 130 (i.e., only extending within the main body housing, such as inner portion 346 of the conduit 134 in FIG. 3). In such a case, the hose 344 may be secured directly to an outer surface of the main body housing 130 or pushed into an inwardly-extending conduit portion (e.g., inner portion 346). The hose 344 may be releasably secured to the air treatment unit 100, such as via clips or magnetic couplings.

It will be appreciated that the air treatment unit may be used as a surface cleaning apparatus when the air treatment unit 100 is provided on (e.g., secured to, the refuse unit 250. In such a case, the air treatment unit 100 may include a long hose 344 for use when mounted to the refuse unit 250 and a shorter hose 344 for use when used without the refuse unite 250 (e.g., when lifted away for use as a hand vacuum or other type of vacuum). The apparatus 100 may include a long hose 344 having a length of more than 3 feet for use when mounted to the refuse unit 250, and a short hose 344 having a length less than 3 feet (e.g., 1-2 feet) for use without the refuse unit 250.

When the air treatment unit 100 is configured as a surface cleaning apparatus 340, then an actuator (e.g., an on/off switch) may be provided. It will be appreciated that any power controls or user interface known for a surface cleaning apparatus may be provided. Accordingly, a user interface 350 may be provided to allow the user to control the operation of the surface cleaning apparatus 340. The user interface 350 may include, e.g., a touch screen or a set of buttons coupled to the powered components (e.g., the suction motor) of the surface cleaning apparatus 340.

### On-Board Power Supply

In accordance with another aspect of this disclosure, the air treatment unit 100 may be provided with an integrated on-board power supply. This aspect may be used by itself or in combination with one or more other aspect of this disclosure including the separate main refuse unit, the use of the air treatment unit as a surface cleaning apparatus and/or a docking station, providing the air treatment unit with an on-board power supply, emptying the air treatment unit using gravity and/or a dirt mover, accessing the refuse unit while the air treatment unit is attached, continuous operation of the air treatment unit while pneumatically isolated from the refuse unit, status-dependent operation, a variable-capacity dirt collection region, a refuse unit including a porous container and reducing dirt release during removal which are set out herein.

In accordance with this aspect, if one or more components of the air treatment unit 100 is a powered component (e.g., an air moving member (suction motor) 300, a powered door actuator, or an interface screen), the air treatment unit 100 includes a power supply 330. It will be appreciated that the air treatment unit 100 may alternatively not include a power supply, such as if no component of the air treatment unit 100 is powered, as exemplified in FIGS. 1 to 8.

As exemplified in FIG. 15, the power supply 330 may comprise an on-board energy storage member 310 and/or a power coupling 312 for drawing power from an external source. If both an on-board energy storage member 310 and a power coupling 312 are provided, then the power coupling 312 may supply power to the components of the air treatment unit 100 (e.g., the motor) directly, and/or to charge the on-board energy storage member 310.

The on-board energy storage member 310 may be a battery, a capacitor, a plurality of batteries, a plurality of capacitors or a combination thereof. The on-board energy storage member 310 may be provided in a pack (e.g., a removeable pack). The pack may be a battery pack. It will be apricated that the on-board energy storage member 310 and/or pack may be provided at any configuration and/or location in the air treatment unit 100.

The power coupling 312 may be a power cord 314 as exemplified in FIG. 15. The power cord 314 may be configured for use with, e.g., residential power supply systems. For example, the power cord 314 may include a multi-pronged head 318 to be plugged into, e.g., a residential power outlet. It will be appreciated that the power cord 314 may be removably attachable to the air treatment unit 100.

Alternatively or additionally the power coupling 312 may include a coupling 316 to receive power from a docked surface cleaning apparatus, as exemplified in FIG. 9. For example, the power coupling 312 may be a coupling arranged to interface with docked vacuum cleaner (e.g., a hand vacuum). The power coupling 312 may be a coupling on the same side as the dirty air inlet 122 and/or clean air outlet 124 (e.g., to be adjacent a docked vacuum that is in air flow communication with the inlet 122 and/or outlet 124). For example, the power coupling 316 may include a plurality of conductive pins to be electrically coupled to a corresponding coupling on a vacuum that is docked with the air treatment unit 100. Such a power coupling 316 may supply power directly to a component (e.g., a suction motor) of the air treatment unit 100 and/or to charge an energy storage member 310.

### Used as a Docking Station

In accordance with an aspect of this disclosure, the air treatment unit 100 is useable as a docking station. This aspect may be used by itself or in combination with one or more other aspect of this disclosure including the use of the air treatment unit as a surface cleaning apparatus, providing the air treatment unit with an on-board power supply, emptying the air treatment unit using gravity and/or a dirt mover, accessing the refuse unit while the air treatment unit is attached, continuous operation of the air treatment unit while pneumatically isolated from the refuse unit, status-dependent operation, a variable-capacity dirt collection region, a refuse unit including a porous container and reducing dirt release during removal which are set out herein.

In accordance with an aspect of this disclosure, the air treatment unit 100 may be useable as a docking station for a surface cleaning apparatus while attached to the refuse unit 250 or while removed therefrom. Accordingly, the air treatment unit may be used to remove dirt that has been collected in the surface cleaning apparatus. It will be appreciated that, when operable as a docking station, the air treatment unit may include an air moving member 300 to transfer (e.g., draw) dirt out of a docked surface cleaning apparatus. Alternately, or in addition, a motor and fan assembly of a docked surface cleaning apparatus may be used to transfer dirt from the surface cleaning apparatus to the air treatment unit 100. It will also be appreciated that, when operable as a docking station, the air treatment unit 100 may have a power supply 330 to power any electrical component of the air treatment unit 100 (e.g., an air moving member, a sensor, an electromechanical door opening mechanism) and/or the docked surface cleaning apparatus may provide the power from an electrical cord connected to the household mains and/or an on board energy storage member.

Air inlet 122, air outlet 124, and/or power coupling 312 of the air treatment unit 100 may be operably connectable to a docked surface cleaning apparatus (e.g., a hand vacuum, wand vacuum, robot vacuum, canister vacuum, upright vacuum, or extractor) to enable the air treatment unit 100 to function as a docking station.

Accordingly, the surface cleaning apparatus may have an emptying air outlet that is used to connect the surface cleaning apparatus to a docking station. Further, the surface cleaning apparatus may have an emptying air inlet that is used to connect the surface cleaning apparatus to a docking station if the suction motor of the surface cleaning apparatus is used during an emptying operation while the surface cleaning apparatus is docked at the air treatment unit 100. Therefore, when the air inlet 122 and, optionally, the air outlet 124 and operably joined to the respective emptying air outlet and, optionally, emptying air inlet of a docked surface cleaning apparatus, then the air inlet 122 and, optionally the air outlet 124, are in air flow communication with the surface cleaning apparatus and a docked air flow path is formed.

If a power coupling 312 is provided then, when a surface cleaning apparatus is docked at the air treatment unit, an electrical connection may be formed between the power coupling 312 of the air treatment unit 100 and a power coupling of the docked surface cleaning apparatus for the transfer of electrical power therebetween.

Operably joining the air inlet 122 to the docked surface cleaning apparatus allows the air treatment unit 100 to be used to evacuate a dirt collection region of the docked surface cleaning apparatus. For example, the dirty air inlet 122 may be located in the docked air flow path downstream of the emptying air outlet of the docked surface cleaning apparatus, and therefore downstream of the dirt collection region of the docked surface cleaning apparatus. Accordingly, air drawn through the dirt collection region of the docked surface cleaning apparatus entrains dirt from the dirt collection region of the docked surface cleaning apparatus and carries that dirt into the air treatment unit 100.

Operably joining the air outlet 124 to the docked surface cleaning apparatus allows the docked surface cleaning apparatus to be used to draw air through the air flow path 120. For example, air may flow from the clean air outlet 124 to the emptying air inlet of the docked surface cleaning apparatus, and then to a clean air outlet of the surface cleaning apparatus with the air moving member (e.g., suction motor) of the docked surface cleaning apparatus in the docked air flow path. Accordingly, the air moving member of the docked surface cleaning apparatus may be used to draw air through the air flow path 120 of the air treatment unit 100.

As discussed previously, the air treatment unit 100 may be used as a surface cleaning apparatus. It will be appreciated that the air treatment unit 100 may be used itself as a surface cleaning apparatus when a surface cleaning apparatus is docked at the air treatment unit 100. In such a case, the motor and fan assembly of the docked surface cleaning apparatus may be used by itself or with an air moving member 300 of the air treatment unit 100 (if an air moving member 300 is provided) when the air treatment unit 100 is operated as a surface cleaning apparatus.

Operably joining the power coupling 312 to a docked surface cleaning apparatus allows electrical power to be transferred between the air treatment unit 100 and a docked surface cleaning apparatus. It will be appreciated that this power transfer may supply power from the air treatment unit 100 to the docked surface cleaning apparatus (e.g., the air treatment unit may be a charging station for the docked surface cleaning apparatus), may supply power from the docked surface cleaning apparatus to the air treatment unit 100 (e.g., the docked surface cleaning apparatus may power the air treatment unit 100 when functioning as a docking station and/or a surface cleaning apparatus), or may transfer power both ways (e.g., controlled by an operating system of the air treatment unit 100 and/or the docked surface cleaning apparatus).

It will be appreciated that, if the air treatment unit is useable as a docking station and not a surface cleaning apparatus, then the air treatment unit 100 need not include a power supply 330. In such a case, the docked surface cleaning apparatus is used to power any electrical component of the air treatment unit 100 (e.g., air moving member 330 and/or a powered door actuator as discussed subsequently) during an emptying operation while the surface cleaning apparatus is docked with the air treatment unit 100.

Optionally, if the air treatment unit 100 includes a power supply 330, then the power supply 330 may be used to charge an on board energy storage member (e.g., battery or capacitor) of the docked surface cleaning apparatus. For example, power cord 314 may be used to draw power from a residential power supply system, which is used to charge an on board energy storage member of the docked surface cleaning apparatus. Alternately or in addition, power storage member 310 of the air treatment unit 100 may be used to charge an on board energy storage member of the docked surface cleaning apparatus. In particular, if the power storage member 310 comprises one or more capacitors, then the air treatment unit 100 may be used to rapidly charge an on board energy storage member of the docked surface cleaning apparatus.

In some embodiments, the air inlet 122, air outlet 124, and/or power coupling 312 are on a common side or end of the air treatment unit 100. As exemplified in FIGS. 1 to 8, the common end or side may be the front end 102. The air inlet 122, air outlet 124, and/or power coupling 312 may be provided adjacent to one or more of the others of the air inlet 122, air outlet 124, and/or power coupling 312 (e.g., to be contacted by a docked surface cleaning apparatus) and they may be on the common side or end. The dirty air inlet 122 may be directly beside (e.g., above) the electrical coupling 312. In other words, the electrical connector 316 may be close enough to the inlet 122 to be concurrently connected to an electrical connector of a surface cleaning apparatus (e.g., an electrical connector that is beside a nozzle or dirty air inlet of a surface cleaning apparatus) as the surface cleaning apparatus is docked with the air treatment unit 100.

Two or more of the air inlet 122, air outlet 124, and power coupling 312 (also referred to as an electrical connector) may be operably joined to the docked surface cleaning apparatus in a single operation (i.e., concurrently). Accordingly, as the surface cleaning apparatus is docked with the air treatment unit, the single act of docking the surface cleaning apparatus to the air treatment unit may operably join the air inlet 122 and the air outlet 124 to the surface cleaning apparatus. As exemplified in FIGS. 1 to 8, the air inlet 122 and the air outlet 124 may be positioned on the air treatment unit 100 so as to be operably joined to the docked surface cleaning apparatus when the surface cleaning apparatus is docked with the air treatment unit 100.

As exemplified in FIGS. 1 and 2, the air treatment unit 100 may optionally include a support for the docked surface cleaning apparatus. The support 360 holds the docked surface cleaning apparatus when the docked surface cleaning apparatus is docked with the air treatment unit 100. The support 360 may optionally releasably secure the docked surface cleaning apparatus to the air treatment unit 100 (e.g., clips or other fasteners). As exemplified in FIGS. 1 to 8, the support 360 may hold up the docked surface cleaning apparatus (e.g., a shelf or cradle) with or without the surface cleaning apparatus being releasably secured to the air treatment unit 100. As exemplified, the support 360 may be a cradle 362 to hold the surface cleaning apparatus, the cradle 362 including at least one recess or pocket 364 (e.g., an area surrounded by a lip) to hold the docked surface cleaning apparatus.

It will be appreciated that the support 360 may be of any suitable configuration. For example, in embodiments in which the support 360 includes a cradle, the cradle may be formed in the top end 106 or top surface of the air treatment unit 100 rather than providing a separate shelf or fastener as exemplified in FIGS. 1 and 2.

Alternatively, as exemplified in FIG. 16, the support 360 may be a plurality of fasteners operable to releasably hold the docked surface cleaning apparatus. As exemption in FIG. 16, the support 360 may be a plurality of hooks on which the docked surface cleaning apparatus may be hung with a port of the docked surface cleaning apparatus in air flow communication with a port of the air treatment unit 100 (e.g., in communication with the inlet 122, when the hose 344 is removed). It will be appreciated that the support 360 may alternatively or additionally include other fasteners, such as clips, magnetic fasteners or threaded fasteners.

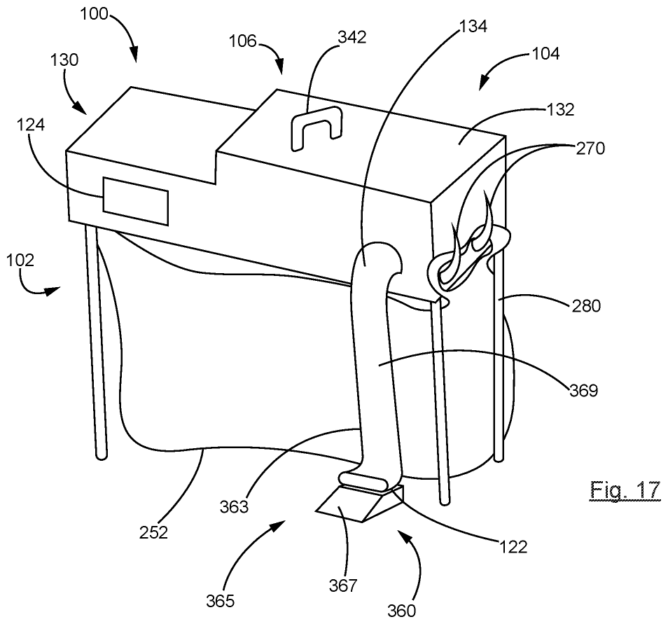

Alternatively, as exemplified in FIG. 17, the support 360 may be a robot docking interface 363. The robot docking interface 363 may include a robot receiving body 365 with the inlet 122 at the robot receiving body 365. The robot receiving body 365 provides a surface accessible to an autonomous robot to hold the autonomous robot as the autonomous robot transfers debris to the dirty air inlet 122. The receiving body 365 may include, e.g., a platform on which the robot may rest and/or a clamp to grasp the robot. The robot receiving body 365 may be shaped for a wheeled robot, and may include a ramp 367 up which the autonomous robot can travel to reach the dirty air inlet 122.

A robot docking interface 363 may include a transfer stage 369 extending from the dirty air inlet 122 to the main body 132 (e.g., to the inlet conduit 134). The transfer stage 369 may be rigid or flexible (e.g., a flexible hose). A rigid transfer stage may maintain the robot docking interface 363 (i.e., the dirt air inlet 122) and the main body 132 at a fixed distance from one another, and may assist in supporting the main body 132 off of the support surface (e.g., floor or ground) when a refuse container 252 (e.g., a flexible garbage bag) is received beneath the main body 132. A rigid transfer stage may be collapsible (e.g., a telescoping conduit may be telescopically collapsed with one segment received in another, or a multi-segment conduit may be folded with one segment against another).

The transfer stage 396, whether rigid or flexible, may be moveable between an in-use configuration and a storage or shipping configuration. In the in-use configuration the dirty air inlet 122 is lower than the main body 132 such that a refuse container 252 may be received below the main body 132 and the dirty air inlet 122 is provided at the support surface (e.g., a floor) to be used by a robot vacuum. The dirty air inlet 122 may be adjacent a lower end of the refuse container 252 in the in-use configuration. In the storage or shipping configuration, the transfer stage 369 may be collapsed (e.g., a flexible hose coiled or bent, or a rigid stage telescopically collapsed) to bring the dirty air inlet 122 closer to the main body 132.

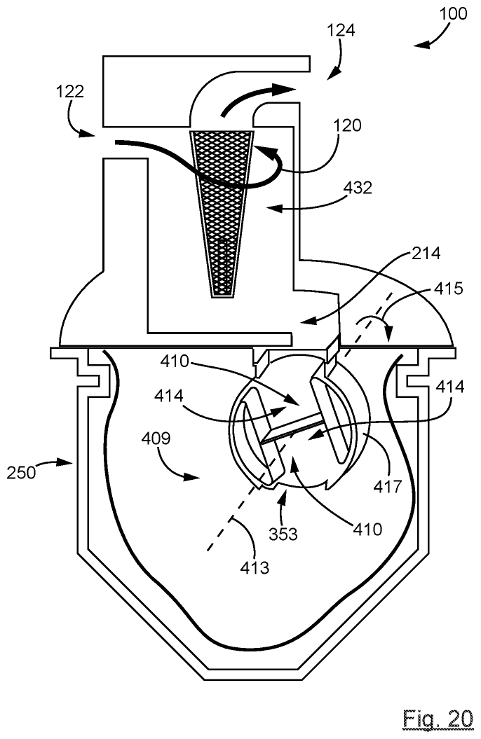

Optionally, as exemplified in FIG. 19, the air treatment unit 100 includes multiple dirty air inlets 122, each selectively openable (e.g., via doors 370 or an openable valve). The different dirty air inlets 122 may be configured differently, such as a dirty air inlet for a robot (e.g., including in a robot docking interface 363) and a dirty air inlet for a hand vac (e.g., including a cradle 362) or a dirty air inlet if the air treatment unit 100 is useable itself as a surface cleaning apparatus. The air flow path 120 extends from an open dirty air inlet to the clean air outlet. For example, the air treatment unit 100 may include a first dirty air inlet 122a to be joined to a docked surface cleaning apparatus and a second dirty air inlet 122b to be applied to a surface. The first and second dirty air inlets 122a, 122b are selectively openable. For example, the first and second dirty air inlets 122a, 122b may each have an openable port door that is opened when connected to a vacuum cleaner (e.g., a robot vacuum cleaner or other docked surface cleaning apparatus) or an accessory cleaning tool is attached.

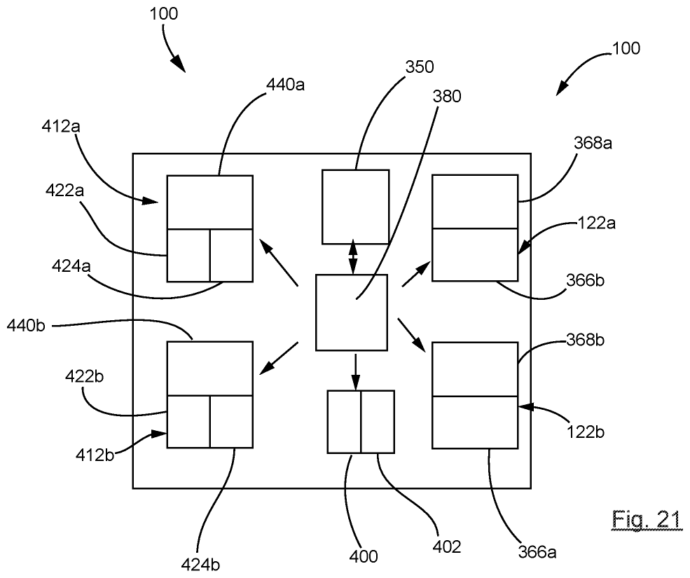

The first and second dirty air inlets 122a, 122b may be controlled by the control system 380, as exemplified in FIG. 21. The control system 380 may be operably coupled to an actuator 366a, 366b operable to open and/or close the door 370a, 370b of the associated inlet 122a, 122b as directed by the control system 380.

Optionally, the control system 380 receives input from a sensor 368a, 368b associated with the door 370a, 370b and responds to that input. For example, a sensor 368a, 368b may indicate whether another device is attached in air flow communication with the inlet (e.g., a hose to inlet 122a and/or a docked surface cleaning apparatus to the inlet 122b). The control system 380 may be operable to open and/or close the door in response to the input. In some embodiments, the control system 380 is operable to close an inlet when no other device is detected by the associated sensor as attached in air flow communicant with the inlet and to open the inlet when another device is detected by the associated sensor as attached in air flow communication with the inlet. It will be appreciated that the inlets may alternatively be opened or closed according to any suitable control scheme, such as a schedule initiated by a user selection of a button or other control (e.g., via interface 350).

The air treatment unit 100 may be used to evacuate the docked surface cleaning apparatus or as a surface cleaning apparatus with the second dirty air inlet applied to a surface (e.g., directly or via a hose or other attachment). Optionally, the suction motor of the docked surface cleaning apparatus is used to draw air through the second dirty air inlet 122b when the air treatment unit 100 is used as a surface cleaning apparatus (i.e., applied to a surface, such as a floor, to clean the surface).

### Dumping in Using Gravity

In accordance with another aspect of this disclosure, the air treatment unit 100 may be emptied using gravity. This aspect may be used by itself or in combination with one or more other aspect of this disclosure including the use of the air treatment unit as a surface cleaning apparatus and/or a docking station, providing the air treatment unit with an on-board power supply, emptying the air treatment unit using a dirt mover, accessing the refuse unit while the air treatment unit is attached, continuous operation of the air treatment unit while pneumatically isolated from the refuse unit, status-dependent operation, a variable-capacity dirt collection region, a refuse unit including a porous container and reducing dirt release during removal which are set out herein.

If the dirt collection region(s) of the air treatment unit 100 are positioned at an elevation above the bottom of the refuse unit, and optionally above the open upper end of the refuse unit 250, then the collected material may be transferred by gravity from the dirt collection region(s) of the air treatment unit 100 to the refuse unit 250. The collected material may fall downwardly directly into an open top of the refuse unit 250. Alternately, the collected material could travel down a ramp that extends downwardly to a location above the open top of the refuse unit 250. The ramp could be the openable dirt dumping door 182. It will be appreciated that, if a ramp is provided, then the opening in the dirt collection region(s) may be positioned laterally outwardly of a perimeter of the open top of the refuse unit 250.

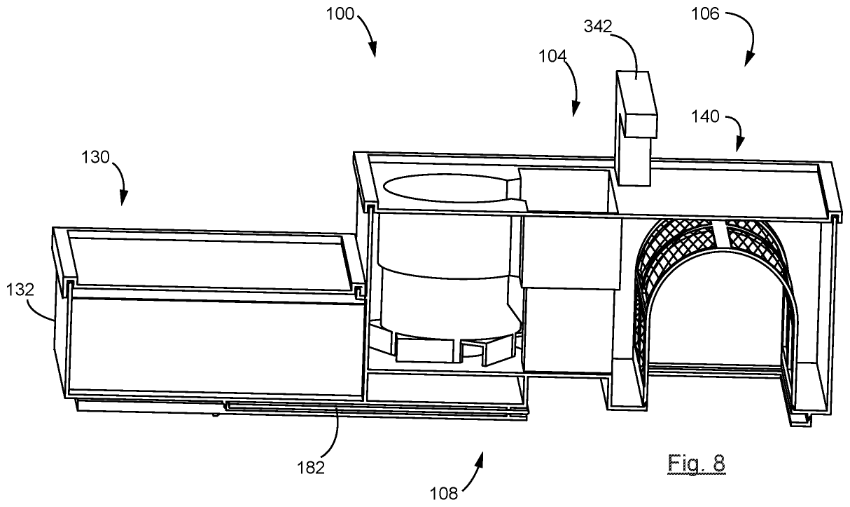

As exemplified in FIGS. 7 and 8, the openable dirt dumping door 182 is opened to provides access to a dirt collection regions of the air treatment unit 100 and allows dirt to fall out of the bottom of the dirt collection regions. As exemplified in FIGS. 9 and 10, the refuse unit 250 is positioned below the dirt collection region(s) of the air treatment unit 100, and optionally all of the air treatment unit 100. In the exemplified embodiments, the dirt collection region(s) of the air treatment unit 100 are located at the lower end 108 of the air treatment unit 100 and the lower wall of the dirt collection region(s) of the air treatment unit 100 are or comprise a lower wall or bottom wall of the air treatment unit 100.

Accordingly, when the dirt collection region(s) of the air treatment unit 100 are open to the dirt collection region 372 of the refuse unit 250 a dirt transfer path 374 is open between the dirt collection region(s) of the air treatment unit 100 and the dirt collection region 372 of the refuse unit 250. Dirt may travel downwardly from the dirt collection region(s) of the air treatment unit 100 to the dirt collection region of the refuse unit 250. It will be appreciated that, as in the embodiment of FIGS. 9 and 10 dirt may fall directly downwardly to the dirt collection region 372 of the refuse unit 250. Alternately, such as if a ramp is used, the dirt transfer path 374 may have a downward component.

As exemplified in FIGS. 1 to 8, the dirt dumping door 182 may include at least part of a floor of a dirt collection region. In other words, the door includes at least a portion on top of which dirt would rest if the dirt collection region contained dirt. As exemplified in FIGS. 1 to 6, the dumping door 182 may be at the lower end 108 of the air treatment unit 100, and may be part of a bottom surface of the air treatment unit 100. The dirt dumping door 182 may include the entire floor of a dirt collection region, as exemplified in FIGS. 1 to 8. It will be appreciated that the dirt dumping door may also or alternately form a lateral wall of a dirt collection region. For example, the dirt dumping door may form a lateral wall of a dirt collection region that has a floor sloped downward towards the lateral wall to encourage dirt to fall out when the door 182 is open.

The dumping door 182 may be opened when the dirt collection region for which it is the openable door is at the same pressure as the refuse unit 250 (e.g., at atmospheric pressure and not under relative positive or negative air pressure). The adjoining dirt collection region may be separated from the air flow path 120 by an openable door as discussed subsequently, or the air flow path 120 itself may be at the same pressure as the refuse unit 250 (i.e., the suction source is turned off or removed from air flow communication with the air flow unit). When the refuse unit 250 and the dirt collection unit are at the same pressure, the dirt dumping door is opened and dirt falls into the refuse unit 250.

It will be appreciated that, for collected material to fall downwardly into the refuse unit 250, the refuse unit 250 may be entirely or mostly below or partially below the dirt collection region(s) of the air treatment unit 100 or the air treatment unit 100 itself. For example, at least 50%, at least 75% or at least 90%, or 100% of the dirt collection region 372 of the refuse unit 250 may be below the dirt collection region(s) of the air treatment unit 100. Alternately, at least 50%, at least 75% or at least 90%, or 100% of the dirt collection region 372 of the refuse unit 250 may be below the air treatment unit 100.

### Dumping Using a Dirt Mover

In accordance with another aspect of this disclosure, the air treatment unit 100 may be emptied using a mechanical member to move dirt out of a dirt collection region of an air treatment member (e.g., into the main refuse unit 250). This aspect may be used by itself or in combination with one or more other aspect of this disclosure including the use of the air treatment unit as a surface cleaning apparatus and/or a docking station, providing the air treatment unit with an on-board power supply, emptying the air treatment unit using gravity, accessing the refuse unit while the air treatment unit is attached, continuous operation of the air treatment unit while pneumatically isolated from the refuse unit, status-dependent operation, a variable-capacity dirt collection region, a refuse unit including a porous container and reducing dirt release during removal which are set out herein.

In accordance with this aspect, a mechanical member is used to move, alone or in combination with gravity, collected material from the dirt collection region(s) of the air treatment unit 100 to the refuse container 250.

Using a mechanical member allows for greater control over the direction of dirt movement and/or the timing of dirt movement. A dirt mover, such as a plunger, may be used to move dirt out of a lateral opening, rather than requiring that the floor of a dirt collection chamber be opened or laterally from an openable bottom dumping door 182. A dirt mover may be used to move dirt out of a dirt collection at a predetermined time, such as when a suction motor is turned off or disconnected, or when the dirt collection chamber is pneumatically isolated from an air flow path. The dirt mover may be part of the air treatment unit 100 or the refuse container 250.

The dirt mover may comprise a dirt moving assembly 351 that may be manually moveable or may be a powered dirt mover. The dirt mover may be a member that physically engages collected material in the dirt collection region(s) of the air treatment unit to push or pull the collected material out of the dirt collection region(s). Accordingly, the dirt mover assembly 351 may comprise, e.g., a scraper that is moveable between a first position (e.g., a dirt collecting position in which dirt is collected in a dirt collection region during operation of the air treatment unit 100) and a second position (e.g., a dirt emptied position in which dirt has been removed from a dirt collection region during operation of the air treatment unit 100)

The dirt moving assembly 351 may form the openable dumping door 182 or it may be operated when or after the dumping door 182 is opened. Accordingly, the dirt moving assembly 351 may drive dirt out of a dirt collection region when the dirt collection region is opened. It will be appreciated that, optionally, movement of the dirt moving assembly 351 to the second position may open the dumping door 182, (e.g., the dirt moving assembly 351 may itself push open the dumping door 182 or it may dirt towards the door 182 and against the door 182 such that a biasing force or lock holding the door 182 shut is overcome and the dirt is pushed out the door 182.

A powered dirt mover may be automatically actuated, such as automatically operated in response to an operating criteria (e.g., if the door 182 is opened and/or an on-board suction motor 300 is turned off and/or a controller issues a signal to an electromechanical member to move the dirt moving assembly 351). Optionally, the powered dirt mover is integrated with a powered door opening assembly to operate with the door opening assembly (e.g., both operated in response to turning off an on-board suction motor 300).

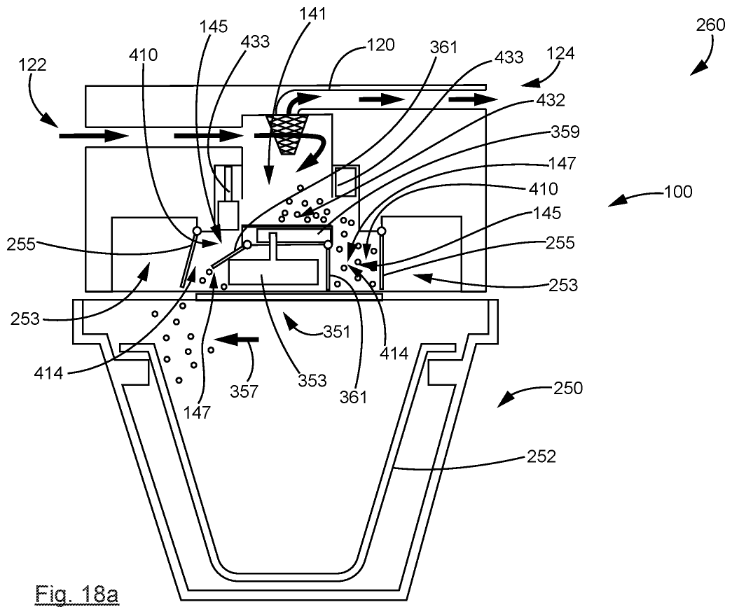

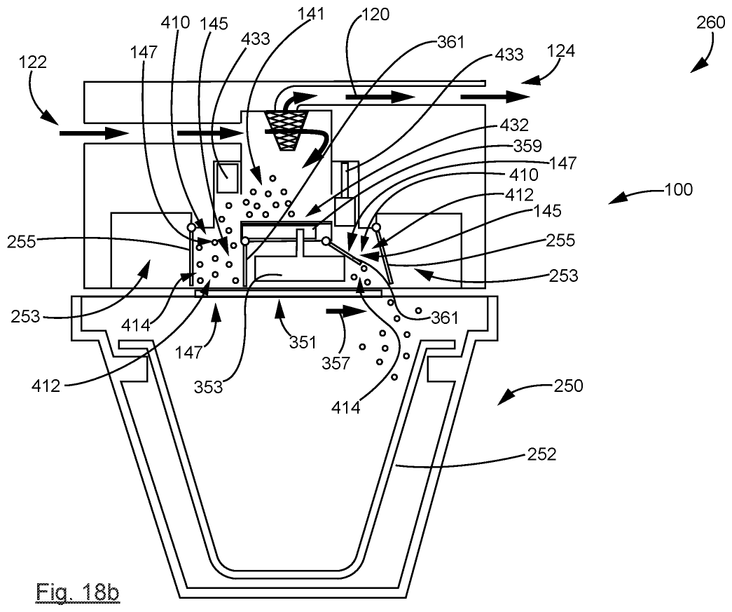

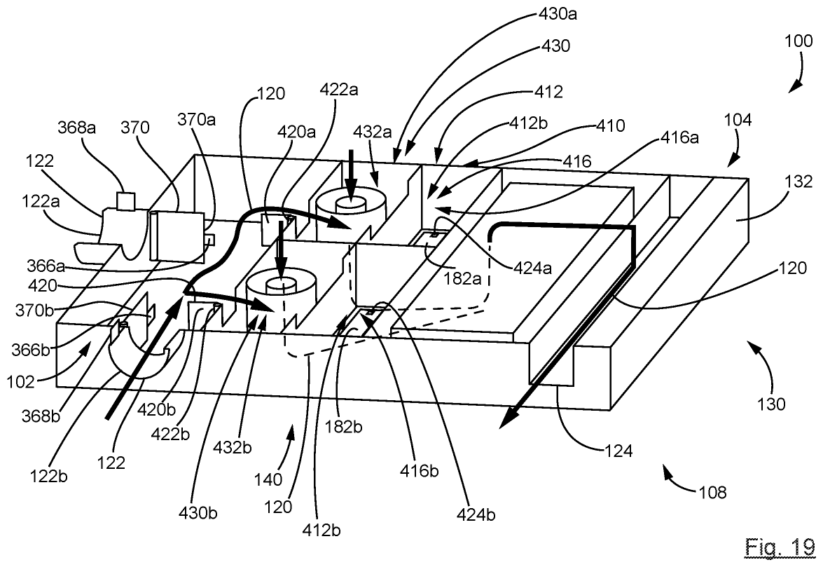

As exemplified in FIGS. 18A and 18B, the dirt moving assembly 351 includes a mechanical member 353 moveable between the first position and the second position. The mechanical member 353 may move generally linearly between the first and second positions, e.g., in movement direction 357. The mechanical member 353 moves through a dirt collection region 145 between the first position and the second position. Thereby pushing dirt through the dirt collection region 145. The dirt moving assembly 351 also includes a drive unit 359 coupled to the mechanical member 353 to move the mechanical member 353. The drive unit 359 may be, e.g., a linear actuator.

As exemplified, the mechanical member 353 may be a piston. The dirt collection region 145 may be a chamber having a generally constant shape along the movement direction 357, and the piston may have a corresponding shape to clear the dirt collection chamber when moving through the dirt collection chamber 147. As exemplified, the piston may move generally linearly from one end of the dirt collection chamber to an opposite end to push dirt out the opposite end (e.g., through passageway 253, such as by pushing open closure member 255).

The mechanical member 353 (e.g., a ram) may move into the dirt collection chamber 147 from a position removed from (exterior to) the dirt collection chamber 147 when moving between the first and second positions. The mechanical member 353 may move through an opening in a wall of the dirt collection chamber 147 into the dirt collection chamber 147. The opening may be selectively closed by a closure member 361 or a leading face of the mechanical member 353. The closure member 361 may be, e.g., biased closed and pushed open by the mechanical member 353 or automatically opened in response to an automated instruction to allow the mechanical member 353 to pass through the opening. The mechanical member 353 moves dirt towards the passageway 253 to the refuse unit 250, and may move all the way to the passageway 253, optionally opening (e.g., pushing open) the closure member 255.

As exemplified, the air treatment unit 100 may include more than one dirt collection region 145. A mechanical member 353 may be operable to move through more than one dirt collection region 145. For example, the mechanical member 353 may move between a position in one dirt collection region 145 out of that dirt collection region 145 and into another dirt collection region 145. As exemplified, the mechanical member 353 may move in a reciprocating motion between two dirt collection regions 145. Selectively openable closure members 433 may pneumatically isolate the dirt collection region in which the mechanical member 353 is located and/or shortly before the mechanical member 353 enters the collection region (e.g., before the closure member 361 of the chamber opens).

It will be appreciated that the dirt moving assembly 351 may optionally be pneumatically operated.

It will also be appreciated that the dirt moving assembly 351 may alternately, or in addition, move collected materially laterally away from the open door 182. For example, it may include a conveyor belt of the like to move dirt laterally to a position at which it may fall in the refuse unit 150.

### Refuse Unit is Accessible While the Air Treatment Unit is Attached

In accordance with another aspect of this disclosure, the refuse unit 250 may be accessible, e.g., as a garbage can by opening a lid or by a portion of the upper end of the refuse unit 250 being exposed while the air treatment unit 100 is mounted in an operating position on the refuse unit 250, while the air treatment unit 100 and the refuse unit 250 are connected together. This aspect may be used by itself or in combination with one or more other aspect of this disclosure including the use of the air treatment unit as a surface cleaning apparatus and/or a docking station, providing the air treatment unit with an on-board power supply, emptying the air treatment unit using gravity and/or a dirt mover, continuous operation of the air treatment unit while pneumatically isolated from the refuse unit, status-dependent operation, a variable-capacity dirt collection region, a refuse unit including a porous container and reducing dirt release during removal which are set out herein.

In accordance with this aspect, the refuse unit 250 is openable while the air treatment unit 100 is provided on the refuse unit 250. Securing the air treatment unit 100 and the refuse unit 250 together allows for easy disposal of dirt collected in the air treatment unit 100, as set out previously. However, if the air treatment unit 100 covers off (overlies all of) the upper opening of a refuse container 252 of the refuse unit 250, then a user may not be able to place waste in the refuse container 250 without lifting off the air treatment unit 100 from the refuse container 250. For example, the refuse unit 250 may be a standard garbage bin that a use purchases or already has and the air treatment unit 100 may be a separate apparatus that is purchased to seat on the top of the garbage bin and convert the garbage bin to a docking station and/or a surface cleaning apparatus.

In order to enable the garbage bin to be used as a waste receptacle, the air treatment unit 100 may be openable to allow the interior of the refuse container 252 to be accessed without removing the air treatment unit 100 from the refuse unit 250. For example, a user seeking to dispose of a larger piece of refuse in the refuse unit without using the air treatment unit 100 to remove the piece of refuse from an airstream may open the air treatment unit 100 and deposit the piece of refuse directly in the refuse unit 250.

As exemplified in FIGS. 9 to 11, the air treatment unit 100 includes a door through the air treatment unit 100 from one side to an opposite side. As exemplified, the door 390 may open through the air treatment unit 100 from the top side 106 to the bottom side 108. When the air treatment unit 100 covers the opening 254 of a refuse unit 250, the door 390 may be opened to allow a user to place a piece of refuse directly into the refuse unit 250. Optionally, a refuse container in the refuse unit 250 may be removeable when the refuse access door 390 is open. Opening the access door 390 may allow a user to replace a refuse container 252 with a replacement refuse container 252. For example, the refuse unit 250 may include a garbage bin 290 lined with a disposable bag 152, and the user may remove the bag 152 to replace the bag with a replacement bag.

As exemplified in FIGS. 9 to 11, the door 390 may be an upper section of the air treatment unit 100 which has the operating components and which is moveably mounted to a frame or flange 392 that seats on the refuse unit 250. The door 390 is moveable between an open position (e.g., as illustrated in FIG. 11, in which the door 390 is pivoted open relative to the flange 392) and a closed position (e.g., as exemplified in FIG. 9, in which the lid 390 is closed against the flange 392). As such, the door 390 may be moveable between the open and closed positions while the portion to which it is moveably secured remains mounted on the refuse unit 250.

The door 390 may be secured to the other portion of the air treatment unit 100 (e.g., the flange 392) by a rotatable member, such as a hinge 395. The door 390 may rotate between the open and closed positions about a rotational axis 391. As exemplified, the door 390 may seat on a stop 397 when in the closed position. In some examples, the door 390 is held by gravity against the stop 397 in the closed position.

As exemplified, the door 390 may include the air treatment assembly 140. This may also allow the user to access an underside of the portion of the housing containing the air treatment assembly 140. For example, the underside of the access door 390 may include the dirt dumping door 182. Optionally, the air flow path 120 is contained in the access door 390. The user may access the dumping door 182 and/or air flow path 120 to, e.g., perform maintenance tasks such as removing a clog.

It will be appreciated that alternatively the door 390 may not include the air treatment assembly 140, air flow path 120, and/or dirt dumping door 182. For example, the access door 390 may be a door through the flange 392 of the housing 130 extending between the air treatment assembly 394 housing and an outer perimeter 396 of the air treatment housing 130, e.g., to one side of the air treatment assembly 140, air flow path 120, and/or dirt dumping door 182. For example, the door 390 may be an openable lid of the air treatment unit 100, which may have a handle, such as the upper wall of the cradle 362 shown in FIG. 1.

### Continuous Operation Pneumatically Isolated from the Refuse Container

In accordance with another aspect of this disclosure, the air treatment unit 100 is continuously operable while transferring dirt from the air treatment unit to the refuse unit without subjecting the refuse unit to positive or negative air pressure. This aspect may be used by itself or in combination with one or more other aspect of this disclosure including the use of the air treatment unit as a surface cleaning apparatus and/or a docking station, providing the air treatment unit with an on-board power supply, emptying the air treatment unit using gravity and/or a dirt mover, accessing the refuse unit while the air treatment unit is attached, status-dependent operation, a variable-capacity dirt collection region, a refuse unit including a porous container and reducing dirt release during removal which are set out herein.

In accordance with this aspect, an air treatment unit 100 may be continuously operated to remove entrained material from an air stream in the air flow path 120 while a dirt collection region of the air treatment unit 100 is isolated from the air flow path 120 whereby collected material in that dirt collection region of the air treatment unit 100 is transferred to the refuse unit 250 while that dirt collection region is at atmospheric pressure.

A dirt collection region of the air treatment unit 100 may be relatively small. Accordingly, as the air treatment unit 100 is operated, the dirt collection region may quickly fill up. As the dirt collection region fills up, the accumulated dirt may affect the operation of the air treatment unit 100 (e.g., reducing efficiency or effectiveness). Accordingly, collected dirt may be transferred to the refuse unit 250. In accordance with this aspect, dirt can be dumped from the air treatment unit 100 into the refuse unit 250 while the air flow path 120 is active without pressurizing or depressurizing the refuse unit 250. For example, as discussed previously, the refuse unit 250 may not be constructed to hold up under pressure or depressurization (e.g., if the refuse unit is or includes a flexible bag).

As exemplified in FIG. 19, the air treatment unit 100 may include a plurality or a set (at least two) 410 of dirt collection regions 412 in parallel. Each dirt collection region is selectively individually connectable in air flow communication with the dirty air inlet 122 so as to collect dirt disentrained from the air stream in air flow path 120. When the dirt collection region is not connected in air flow communication with the dirty air inlet 122, the dirt collection region may be opened to the refuse unit 250 without subjecting the refuse unit 250 to positive or negative air pressure even if the dirty air inlet is under negative air pressure.

Accordingly, in operation at least one dirt collection region of the set 410 is in air flow communication with the dirty air inlet 122 and at least one other of the set 410 is pneumatically isolated from the dirty air inlet 122. For example, if the set 410 consists of two dirt collection regions, the two may alternate which of the two is in air flow communication with the dirty air inlet 122. Accordingly, a first dirt collection region may be is isolated from the air flow may then opened and emptied in any manner disclosed herein. The second dirt collection region may remain in operation to collect dirt. After the first dirt collection region is emptied, the first dirt collection region may be closed (e.g., a door 182 closed) and the dirt collection region may then be reconnected to the air flow path 120 to collect dirt. The second dirt collection region may then be isolated from the air flow may then opened and emptied in any manner disclosed herein. This sequence may be continued while the air treatment unit 100 is in operation thereby allowing continuous operation even though the dirt collection regions of the air treatment unit 100 are relatively small.

As exemplified in FIG. 19, the set of dirt collection regions 410 includes a set or plurality of chambers 414 arranged in parallel and an isolation door 420 associated with each chamber of the set 414. Each isolation door 420 is operable between an open position in which the associated chamber is in communication with the dirty air inlet 122 and a closed position in which the associated chamber is isolated from the dirty air inlet 122. In some embodiments, each chamber 416 of the set of chambers 414 is selectively isolatable from the air flow path 120.

As exemplified in FIG. 19, the isolation door 420 may isolate the entire air treatment member 430, including an air treatment chamber 432 and a dirt collection region 412, from the dirty air inlet 122. Alternately, if an external dirt collection chamber is provided, only the dirt collection chamber may be isolated.

As exemplified in FIG. 19, the air treatment unit 100 may include a first air treatment member 430a which is selectively connectable in air flow communication with the dirty air inlet 122. The first air treatment member 430a includes a first air treatment chamber 432a and a first dirt collection region 412a (e.g., in a first dirt collection chamber 416a). The first collection region 412a has an emptying door 182a which is operable between a closed position and an open position. The air treatment unit 100 also concludes a second air treatment member 430b which is selectively connectable in air flow communication with the dirty air inlet 122. The second air treatment member 430b includes a second air treatment chamber 432b and a second dirt collection region 412b (e.g., in a dirt collection chamber 416b). The second collection region 412b has an emptying door 182b which is operable between a closed position and an open position. The air treatment unit 100 is operable in a first operating mode in which the first air treatment member 430a is in air flow communication with the dirty air inlet 122, the emptying door of the first dirt collection region is closed, the second air treatment member 430b is isolated from air flow communication with the dirty air inlet 122 (e.g., by isolation door 420) and the emptying door of the second dirt collection region is openable whereby dirt is emptied from the second dirt collection region (e.g., into refuse unit 250). The air treatment unit 100 is also operable in a second operating mode in which the second air treatment member 430b is in air flow communication with the dirty air inlet 122, the emptying door of the second dirt collection region is closed, the first air treatment member 430a is isolated from air flow communication with the dirty air inlet 122 (e.g., by isolation door 420) and the emptying door of the first dirt collection region is openable whereby dirt is emptied from the first dirt collection region (e.g., into refuse unit 250).

It will be appreciated that any suitable arrangement of dirt collection regions may be used.

The air treatment chamber 432 may be selectively connected to one (or more) of a set of dirt collection regions 410, each in a fixed position relative to the air treatment chamber 432 by opening and closing different closure members (e.g., pivotal or sliding doors). For example, as exemplified in FIGS. 18A and 18B, an air treatment chamber 432 (e.g., a cyclone) may have two dirt collection chambers 145, 147. A closure member 361 is provided for each dirt collection chamber 145, 147 to isolate each dirt collection chamber 145, 147 from the air treatment chamber 432. Accordingly, each closure member 361 may open and close its respective dirt collection chamber 145, 147 and that dirt collection chamber 145, 147 may then be emptied by opening closure member 255 (which may be a door 182).

Alternately, as exemplified in FIGS. 20 and 21, a single moving member may be used to sequentially connect an air treatment chamber 432 with a one or more of a plurality of discrete dirt collection regions 410 (e.g., a plurality of discrete dirt collection chambers 414) and each dirt collection region 410 may be selectively individually connectable in air flow communication with the single air treatment chamber 432, such that the single air treatment chamber 432 may be continuously used while switching between the dirt collection region 410 to which dirt is directed. In this example, a rotating member with one or more openings selectively blocks fluid communication between the air treatment chamber 432 and a dirt chamber 414 when the opening(s) are not aligned.

As exemplified in FIG. 20, the apparatus 100 may include a moveable dirt collection assembly 409. The air treatment chamber 432 may be selectively connected to one (or more) of a set of dirt collection regions 410 at a time. The dirt collection regions 410 may be moveable relative to the air treatment chamber 432. The dirt collection regions 410 may move together as one body. The dirt collection regions 410 may be formed by one or more moveable member 411 moveable between a first position in which a first of the dirt collection regions 410 is in fluid communication with the air treatment chamber 432 and a second position in which a second of the dirt collection regions 410 is in fluid communication with the air treatment chamber 432.

As exemplified, the moveable member 411 may be a rotatable member rotationally mounted to move about a rotational axis 413 (e.g., in movement direction 415). The moveable dirt collection assembly 409 may be a rotary assembly. As exemplified in FIG. 20, the moveable member 411 may be received in a rotational housing 417. As the rotational member 411 rotates, the dirt collection regions 410 are moved between a position open to the air treatment chamber 432 and a position open to a passageway 353 to the refuse unit 250. Passageway 353 may be provided without a closure member, e.g., without the closure member 355 provided in other examples. The dirt outlet 214 may be provided without a closure member, e.g., without the closure member 433 provided in other examples. It will be appreciated that the rotational member 411 may be moved periodically, such as by a stepper motor, so as to periodically connect a dirt collection region 410 with the air treatment chamber 432. Alternately, the rotational member may continually rotate at a constant rate.

Control over the selective connection of the dirt collection regions with the dirty air inlet 122 may be controlled manually and/or automatically. For example, a user may slide isolation doors open or closed as desired (e.g., using a handle that extends outside the housing). A control system 380 of the air treatment unit 100 may control the selective connection of the dirt collection regions (e.g., by opening and closing the isolation doors 420a, 420b). To do so, the control system 380 may be operably coupled to an actuator 422a, 422b for each isolation door 420a, 420b, the actuator operable to move (e.g., drive) the door to an open and/or closed position. The control system 380 may also control opening and closing of dumping doors 182a, 182b. To do so, the control system 380 may be operably coupled to an actuator 424a, 424b for each dumping door 182, 182b, the actuator operable to move (e.g., drive) the door to an open and/or closed position.

It will be appreciated that in some embodiments one or more doors may be controlled mechanically, such as manually locked, unlocked, opened, and/or shut by a user or automatically locked, unlocked, opened, and/or shut by a mechanical state of the air treatment unit 100 (e.g., whether another surface cleaning apparatus is docked with the unit 100).

The control system may follow a preset schedule and/or respond to input (e.g., user input, such as via interface 350, or sensor input). For example, a schedule may include connecting a first dirt collection region to the dirty air inlet 122 for a predetermined connection time, such as at least 20, 30, 40, 50, or 60 seconds, or between 5 seconds and 90 seconds, 10 seconds and 75 seconds, or 20 seconds and 60 seconds. The schedule may include disconnecting a second dirt collection region for a predetermined disconnection time, which may be the same as the predetermined time for the first dirt collection region to be in fluid flow communication or different (e.g., at least 20, 30, 40, 50, or 60 seconds, or between 5 seconds and 90 seconds, 10 seconds and 75 seconds, or 20 seconds and 60 seconds). If a dumping door 182 is to be opened, as in the embodiment of FIG. 19, then the dumping door may be opened for the same time (or a different time) as the dirt collection region is isolated from the dirty air inlet 122. It will be appreciated that one or more of the connection time, disconnection time, and dumping time may be the same as one or more of the others of the connection time, disconnection time, and dumping time. For example, with two dirt connection regions in parallel, one may be disconnected for the duration of the time the other is connected, and they may alternate. It will be appreciated that, optionally, the dumping door is opened after the dirt collection chamber is isolated from the dirty air inlet 122 and is closed before the dirt collection chamber is reconnected to the dirty air inlet 122.

It will be understood that the disconnection time may be less than the connection time. For example, if emptying a dirt collection region takes less time than filling the dirt collection region, a dirt collection region may be brought online (i.e., connected in air flow communication with the dirty air inlet) before another needs to be taken offline (i.e., disconnected from air flow communication with the dirty air inlet) and they may operate in tandem. Accordingly, at least dirt collection region may be in communication with the dirty air inlet 122 at all times during operation of the air treatment unit 100.

Where the control system responds to sensor input a sensor may detect when a predetermined volume and/or weight of dirt has collected in a dirt collection region (e.g., a photoelectric sensor or weight sensor), in response to which the dirt collection region may be disconnected and/or the dumping door 182 may be opened. As another example, a sensor may detect when dirt has been removed from a dirt collection region and/or a dumping door 182 has been closed after opening, in response to which the dirt collection region may be connected in air flow communication with the dirty air inlet 122.

As exemplified in FIG. 21, the control system 380 may control opening and closing of the dumping doors 182a, 182b and the isolation doors 420a, 420b. The control system 380 may be operable to open and close the doors 182a, 182b, 420a, 420b in accordance with a schedule, sensor values, and/or user input.

As exemplified in FIG. 21, each of the first and second dirt collection regions 412a, 412b (e.g., chambers 416a, 416b), may include a sensor 440a, 440b to detect when a predetermined volume of dirt has collected in the region, and indicate a volume accumulation detection event. The control system is communicatively coupled to the sensors to receive the event and respond by taking the chamber offline and dumping the contents (e.g., closing the isolation door and opening the dumping door). The control system may be configured to prevent all dirt collection regions from being taken off line at once.

### Status-Dependent Operation

In accordance with another aspect of this disclosure, operation of the air treatment unit based on the evacuation status of the air treatment unit or an air treatment member thereof is restricted. This aspect may be used by itself or in combination with one or more other aspect of this disclosure including the use of the air treatment unit as a surface cleaning apparatus and/or a docking station, providing the air treatment unit with an on-board power supply, emptying the air treatment unit using gravity and/or a dirt mover, accessing the refuse unit while the air treatment unit is attached, continuous operation of the air treatment unit while pneumatically isolated from the refuse unit, a variable-capacity dirt collection region, a refuse unit including a porous container and reducing dirt release during removal which are set out herein.

When the air treatment unit or an air treatment member thereof is in operation as a surface cleaning apparatus or as a docking station (e.g., an active or evacuating state), a component of the air treatment unit 100 may be limited in operation. Accordingly, the air flow path 120 may remain as a closed path other than the air inlet and the air outlet when the air treatment unit 100 is in operation. For example, the component that is limited in operation may be a door that is lockable to limit opening the door when the air treatment unit 100 is in operation.

As exemplified in FIG. 1, a lock 400 may be moveable between a locked state in which the door is locked shut, and an unlocked state in which the door is openable.

Any suitable lock 400 may be used. For example, the lock 400 may include a first lock member on the door and a second lock member on a housing portion adjacent the door (e.g., a latch with a hook member on the door and a loop member on the housing portion adjacent the door). Alternatively, the lock 400 may include a member only on the door or only on the housing portion adjacent the door (e.g., an arm mounted to the housing portion adjacent the door that is moveable to a position blocking opening of the door).

The state of a lock on the door may depend on the operational state of the air treatment unit. The door may be locked when the air treatment unit is active, that is, when the dirty air inlet is subject to a negative air pressure. The door may be unlocked when the dirty air inlet is at atmospheric pressure. The door may open into a chamber or set of chambers in the air treatment unit (e.g., an access door to allow a user to access the chamber or set of chambers), and the door may be locked when the chamber or set of chambers is subject to a negative or positive air pressure. The door may be unlocked when the chamber or set of chambers is at atmospheric pressure. It will be appreciated that a lock 400 may be locked and/or unlocked in any suitable way. The lock 400 may be locked or unlocked manually, by the control system 380 issuing a signal to an electromechanical member, pneumatically using air flow through the air flow path 120 to move the lock to the locked position and/or mechanically by a mechanical prerequisite (e.g., by the act of docking another surface cleaning apparatus with the air treatment unit 100).

As exemplified in FIG. 1, the lock 400 locks shut the filter access door 234. It will be appreciated that the lock 400 may alternatively lock shut any other door of the air treatment unit 100, the lock 400 may lock shut a plurality of doors of the air treatment unit 100 (e.g., one lock holding more than one door locked or unlocked), and/or there may be additional locks 400 governing whether other doors are locked shut (e.g., a lock 400 for the filter access door 234, a lock 400 for the common access door 220, and a lock 400 for each dirt dumping door).

During operation of the air treatment unit 100 when air is flowing through the air flow path and/or a chamber (e.g., a dirt collection chamber) is under positive or negative pressure, the lock 400 may be inhibited from moving to the unlocked position. For example, the control unit 380 may receive sensor input from a sensor indicating that a chamber having the door that is locked by the lock 400 is under positive or negative pressure and, in response, hold the lock 400 in the locked position. The sensor may be an air pressure sensor or an air flow sensor.

For example, when the air flow path 120 is active (negative or positive pressure) the dirt dumping door 182 of any dirt collection region that is in communication with the air flow path 120 may be locked. Additionally or alternatively, the refuse access door 390, filter access door 234, dirt region access door 244, air treatment access door 242, and/or common access door 220 may be restricted (locked closed) in response to an operating state of the air treatment unit 100, air flow path 120, or air treatment assembly 140.

Alternately, or in addition, the lock may be locked with the air moving member 300 is actuated and the lock may be unlocked when the air moving member 300 is deenergized.

For example, if the air treatment unit 100 is used as a docking station, then the air treatment unit 100 may include an evacuation actuator 402. Actuation of the evacuation actuator 402 may initiate an evacuation operation and also move the lock into the locked position (e.g., physically drives the movement of a lock member to the locked position) and/or holds the lock in the locked position (e.g., blocks movement of the lock that would unlock the lock 400). The evacuation actuator 402 may remain activated as long as the evacuation operation continues (e.g., as long as an on-board suction motor is moving air or as long as the chamber opened by the door locked by the lock is under negative or positive air pressure).

In some embodiments, the operational status-dependent restriction may be activated automatically in response to setting the relevant operational status. Such automatic activation may be a response to a sensor detecting the operational status or may be a response to the action that set the operational status. For example, a sensor may detect that a chamber that the door opens is under positive or negative air pressure, and lock the door in response. Alternatively or additionally, the door may be locked in response to activating an air moving member 300 of the air treatment unit 100 or joining an associated chamber into which the door opens to a powered air moving member 300. For example, a dirt region access door may be locked when a user turns on a suction motor 300 (e.g., presses a power button) and/or when a user couples the associated dirt collection region in air flow communication with a suction motor that is on (e.g., opens a door or reroutes the air flow path 120).

In some embodiments, one or more door is locked in response to turning on the air moving member 300 of the air treatment unit 100. For example, a single toggle (e.g., button or switch) may be coupled to the air moving member 300 to turn on the air moving member 300, and activating the toggle to turn on the air moving member 300 may also lock one or more door (e.g., the refuse access door 390, filter access door 234, dirt region access door 244, air treatment access door 242, and/or common access door 220).

### Variable-Capacity Dirt Collection Region

In accordance with another aspect of this disclosure, a variable-capacity dirt collection region, which may be used with the air treatment unit 100 and or the refuse unit 250 is provided. This aspect may be used by itself or in combination with one or more other aspect of this disclosure including the use of the air treatment unit as a surface cleaning apparatus and/or a docking station, providing the air treatment unit with an on-board power supply, emptying the air treatment unit using gravity and/or a dirt mover, accessing the refuse unit while the air treatment unit is attached, continuous operation of the air treatment unit while pneumatically isolated from the refuse unit, status-dependent operation, a refuse unit including a porous container and reducing dirt release during removal which are set out herein.

In accordance with this aspect, the dirt collection volume of a cleaning assembly 260, may be variable. It will be appreciated that, in accordance with this aspect, the volume of the refuse unit 250 may be variable. Alternately, an air treatment unit 100 may be provided with a dirt collection chamber having a variable capacity.

In either case, the refuse unit 250 or a variable volume dirt collection chamber that is attached to an air treatment unit 100 may be at atmospheric pressure when dirt is transferred from the air treatment unit 100, to the refuse unit 250 or the variable volume dirt collection chamber that is attached to an air treatment unit 100. Accordingly, the refuse unit 250, or the variable volume dirt collection chamber that is attached to an air treatment unit 100, need not be constructed to withstand the typical pressure within a vacuum cleaner. Therefore, the dirt collection portion of the refuse unit, or the refuse unit itself or the variable volume dirt collection chamber that is attached to an air treatment unit 100, may be formed so as to be expandable (e.g., by using a flexible bag, telescoping wall portions or the like).

The cleaning assembly 260 may be used to collect a small amount of dirt or a large amount of dirt. The cleaning assembly 260 may be used to collect a small amount of dirt and then a large amount of dirt. The cleaning assembly 260 may be small when the amount of dirt collected in the cleaning assembly 260 is small, and then expand as more dirt is collected to contain the collected dirt. It will be appreciated that a smaller cleaning assembly 260 may be desirable in some circumstances (e.g., for maneuverability or storage requirements) while a large cleaning assembly 260 may be desirable in other circumstances (e.g., to contain a large amount of dirt).

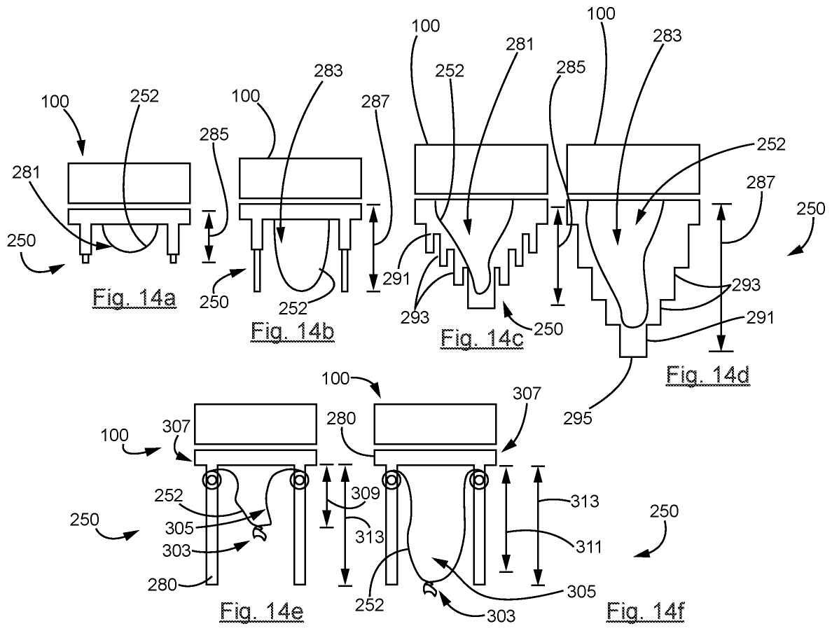

Referring to FIGS. 14A-14F, the container 252 of the refuse unit 250 has a variable-capacity. In a given configuration, the cleaning assembly 260 has a given capacity or interior volume in which dirt can be received. The capacity or interior volume may include, e.g., the dirt collection region(s) of the air treatment member(s) of the air treatment unit 100 and the interior volume of the container 252 of the refuse unit 250. The container 252 of the refuse unit 250, or the refuse unit 250 itself if no container 252 is provided, may be reconfigurable between a first configuration in which it has a first capacity and a second or subsequent configuration in which it has a second or subsequent capacity that is larger than the preceding capacity. Accordingly, the capacity of the air treatment unit 100 may be a fixed capacity.

As exemplified in FIGS. 14A-14F, as discussed previously, the air treatment unit 100 may be removably mountable to a refuse unit 250. Alternately, as exemplified in FIGS. 1 and 2, a variable volume dirt collection chamber comprises a refuse unit 250 that is attached to an air treatment unit 100 and the air treatment unit 100 may be useable, e.g., as a vacuum cleaner, while the variable volume dirt collection chamber is attached thereto. As the refuse unit may be formed of, e.g., a lightweight frame 280 with a flexible bag attached thereto, the refuse unit may be light weight and not add any substantial with to the air treatment unit 100, thereby enabling the cleaning assembly 260 to be useable, e.g., as a hand held vacuum cleaner.

As exemplified in FIG. 16, the surface cleaning apparatus 340 may include and/or be used with a refuse unit 250, such as a flexible bag 252. It will be understood that the bag may be supported, such as by a garbage can or frame 280. Including a refuse unit 250 and/or using the surface cleaning apparatus 340 with the refuse unit 250 may increase the dirt collection capability of the surface cleaning apparatus 340. The refuse unit 250, pneumatically isolated from the air flow path 120 when the air flow path is active, acts as a large-capacity dirt collection region, and may be easy to expand as needed and/or to dispose of when full.

The variable volume container (e.g., bag) may be secured directly to the air treatment unit 100 or it may be held on an expandable frame 280, or within a ridged walled housing (e.g., a bag lining the garbage bin 290 of FIG. 9), which may be part of the air treatment unit 100 or a refuse unit 250. The holder 280 may be releasably attached to the air treatment unit 100 (e.g., the air treatment unit 100 may be used with or without the holder 280).

The capacity of the container 252 may vary as a support structure (e.g., an expandable frame 280) is reconfigured, as the container 252 itself is reconfigured or the container 252 may have a variable configuration while it's support structure 280 has a fixed shape or configuration Accordingly, the variable capacity may be provided by using a flexible container (e.g., disposable bag) which may be mounted directly to an air treatment unit 100 or by using a refuse unit that has a frame to which a flexible container may be removably attachable. The frame may be height adjustable so as to expand as the desired volume of the is increased. Alternately, a variable volume container which does not require a frame (such as a container with telescoping walls) may be used.

The refuse unit 250 or container 252 or the variable volume dirt collection chamber that is attached to an air treatment unit 100 may have at least one flexible wall. A flexible wall allows the container to expand for use. For example, the flexible wall allows the container to be stored in a collapsed or partially collapsed state, and may allow the container to be used with the air treatment unit 100 in the collapsed or partially collapsed state. The container may then expand during use, such as expanding as it is filled with dirt from the air treatment unit 100. Accordingly, the refuse unit 250 or container 252 or the variable volume dirt collection chamber that is attached to an air treatment unit 100 may be or comprise a bag (i.e., a flexible-walled container). It may comprise a container that is formed of cellulose (e.g., a paper bag). For example, it may be a cellulose bag or include a wall made of cellulose or it may be or include a disposable bag. As exemplified in FIGS. 1 and 2, a plastic garbage bag is used.

As exemplified in FIGS. 1 and 2, the refuse container holder 280 is adjustable. For example, the refuse container holder 280 may have an adjustable height (e.g., an extendable such as telescoping frame or support). The refuse container holder 280 removably receives the refuse container (e.g., a disposable refuse container such as a plastic garbage bag). The refuse container 252 may be removably secured to the holder 280 so that the container 252 is supported by the holder 280 at a plurality of points. For example, the holder may include a plurality of fasteners (e.g., clips or hooks) to grasp the container 252. Optionally, the refuse container holder 280 forms a chamber (e.g., a garbage bin) and the refuse container 252 lines the refuse container holder 280 (e.g., the refuse container 252 lines the interior of the garbage bin and may extend over the rim of the bin).

As exemplified in FIGS. 1 and 2, the holder 280 is an apparatus having different configurations, with at least one first retracted configuration, in which telescoping legs 282b are received in legs 282a, and at least one extended configuration in which telescoping legs 282b are telescoped out from legs 282a. Optionally, each of legs 282a and 282b include at least one fastener 284 for holding the container 252. The container 252 may be secured to the various fasteners 284 at spaced-apart locations. Accordingly, as the stages are move apart relative to one another, the container 252 may also be opened up. Accordingly, the frame 280 is able to expand with the flexible-walled container 252 supported by the frame 280.

The frame 280 may assist in holding the flexible-walled container 252 open and/or provide a stable base on which to rest the air treatment unit 100 when placing the assembly down (e.g., when a user sets the assembly down on a table, counter, or floor).

As exemplified in FIGS. 14A-14D, the support structure 280 is a variable-configuration structure. The support structure 280 can be reconfigured to expand and contract an interior volume within a container 252. The support structure 280 has a first configuration (e.g., FIG. 14A or 14C) which provides a first volume 281 in which the container 252 is provided and a second configuration (e.g., FIG. 14B or 14D) which provides a second volume 283 in which the container 252 is provided. The second volume 283 is larger than the first volume 281, allowing the container 252 to be spread out further or expand to contain more dirt. For example, the support structure 280 may be used with a pre-formed bag having a fixed maximum volume, and the bag may be folded up or otherwise collapsed when arranged in a smaller volume.

In some embodiments, the first volume 281 has a height 285 that is shorter than a height 287 of the second volume 283. Even where the volume 281 is opened laterally, a shorter height may restrict the degree to which the bag 252 is spread out, since the bag 252 may hang down within the volume 281. While the bag 252 could be spread out laterally while received in the volume 281 to contain more dirt, expanding the height 285 to the height 287 may make containing more dirt easier. Accordingly, the capacity of the refuse container 252 may vary as the support capacity of the support structure 280 varies.

As exemplified in FIGS. 14A and 14B, the legs or other framework may be reconfigurable, such as by telescoping a lower stage out of an upper stage or by folding a lower stage down from an upper stage.

As exemplified in FIGS. 14C and 14D, the support structure 280 support structure 280 may be, e.g., a collapsible container. One or more of the walls of the support structure 280 may be flexible (e.g., a flexible sidewall 291), and may include a plurality of wall portions 293 which can be collapsed into position next to one another (FIG. 14C) or moved one below another (FIG. 14D). The interior volumes 281, 283 may each be enclosed by the lateral walls and/or a floor 295. The base of the support structure 280 may rest upon, e.g., a floor or other support surface. In some embodiments, the collapsible structure having the plurality of wall portions 293 is the refuse container 252 (i.e., not lined with a separate refuse container 252 such as a bag, rather the dirt is dumped directly into the collapsible structure having the plurality of wall portions 393).

Also, or alternatively, the container 252 itself may be reconfigured between a first configuration having a first maximum volume when spread out and a second configuration having a second maximum volume when spread out, the second maximum volume being larger than the first maximum volume. For example, the container 252 may be formed from a continuous tube 301 of flexible material tied at an end 303 to close the bottom 305 of the container 252 and unrollable at an opposite end 307 to extend the length 309 of the container 252. The tube 301 may be unrolled to a first length 309 (FIG. 14E) at which the container 252 has the first maximum volume when spread out, and then unrolled further to a second length 311 (FIG. 14F) at which the container 252 has a second maximum volume when spread out. Optionally, the shape, e.g., the height 313 of the support structure 280 is fixed.

### Refuse Unit Including a Porous Container

In accordance with another aspect of this disclosure, a porous container may be used, e.g., with the air treatment unit 100 and/or the refuse unit 250. This aspect may be used by itself or in combination with one or more other aspect of this disclosure including the use of the air treatment unit as a surface cleaning apparatus and/or a docking station, providing the air treatment unit with an on-board power supply, emptying the air treatment unit using gravity and/or a dirt mover, accessing the refuse unit while the air treatment unit is attached, continuous operation of the air treatment unit while pneumatically isolated from the refuse unit, status-dependent operation, a variable-capacity dirt collection region and reducing dirt release during removal which are set out herein.

In accordance with this aspect of the disclosure a porous container (e.g., a porous bag) may be used in a similar manner to a variable capacity container. The use of a porous container (e.g., a cloth or paper filter bag) allows the porous container to act as a filter bag. Accordingly, the bag may act as a first air treatment stage in the air flow path 120 and remove dirt from the air flow path directly, instead of and/or in addition to dirt being transferred from an air treatment member in the air treatment unit 100 back into the bag. The bag may therefore remove course dirt and only fine dirt may travel downstream to one or more further air treatment members. The downstream air treatment member or members may optionally empty dirt back into the bag as discussed previously. Alternately, the bag may be the only air treatment member of the apparatus.

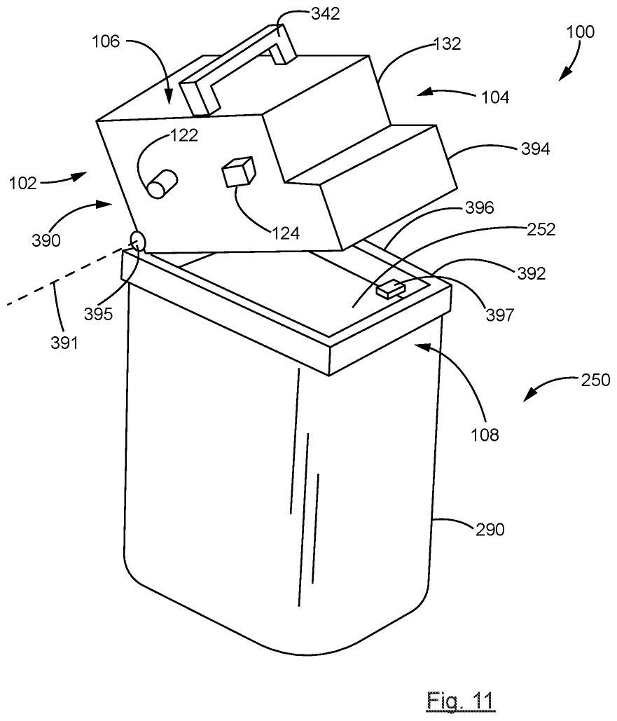

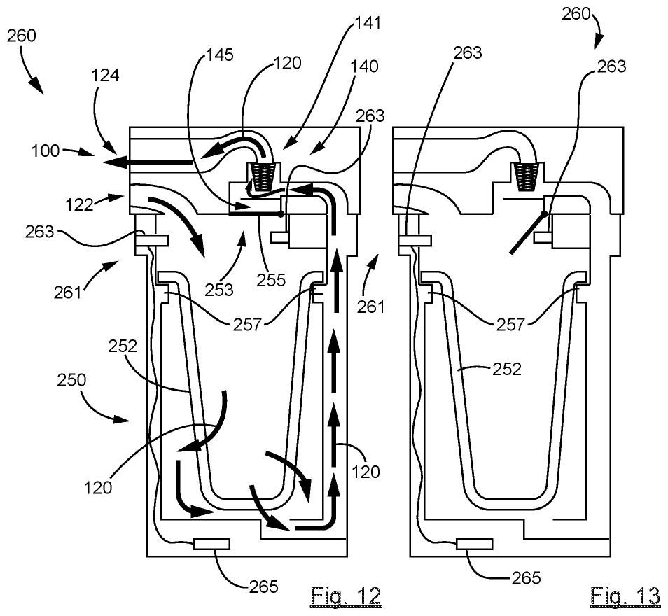

As exemplified in FIGS. 12 and 13, a porous container 252 is provided in the refuse unit 250 and is in the air flow path 120. Accordingly, the refuse unit provides an outer air impermeable structure so that air, after passing through the porous container, travels into the air treatment unit 100. The air flow path 120 extends from the air treatment unit 100 into the refuse unit 250 upstream of the container 252 and then from the refuse unit 250 back to the air treatment unit 100 downstream of the container 252. Accordingly, the air flows from the dirt air inlet 122 through pores in the porous container 252 into the air treatment unit 10 and out through the clean air outlet 124.

It will be appreciated that the refuse unit 250 and the porous container 252 may be of any construction which creates an air flow path from the downstream side of the porous container back to the air treatment unit 100. Accordingly, only a portion of the container may be porous and the refuse unit may have an air impermeable wall that encloses only the porous portion of the container 252.

As exemplified in FIGS. 12 and 13, the container 252 is a filter bag. The is removably positioned in the refuse unit 250 with a top rim of the container 252 hanging from a lip or rim 257 formed in the refuse unit 250 or by a top rim 292 of the refuse unit 250.

As exemplified, one or more other (e.g., downstream) stages may empty into the porous container 252. As exemplified, another air treatment member 141 may include a dirt collection region 145 which is emptiable into the porous container 252. The dirt collection region 145 may in fluid communication with the 252, such as via a passageway 253. As discussed previously and as exemplified, passageway 253 is an opening in a wall of a dirt collection chamber leading directly to a chamber in the refuse unit 250 in which the porous container 252 is received in the in-use position illustrated, however it will be appreciated that the passageway 253 may be longer and/or less direct. The passageway 253 is selectively closed by a closure member 255. The closure member 255 may be, e.g., a door. As exemplified in FIGS. 12 and 13, the closure member 255 may be a pivotal door moveable between a closed position (FIG. 12) closing the passageway 253 and an open position (FIG. 13) in which the closure member 255 is at least partially removed from the passageway 253 and the dirt collection region 145 is in fluid communication with the porous container 252 via the passageway 253.

FIGS. 12 and 13 exemplify a single dirt collection region 145 emptiable into the porous container 252. However as discussed previously the air treatment unit 100 may include more than one dirt collection region 145 that is emptiable into the porous container 252. It will be appreciated that any construction of an air treatment unit 100 to transfer dirt to a refuse unit 150 may be used.

In embodiments in which a dirt collection region 145 is emptiable into the porous container 252, the dirt collection region 145 may be emptiable after the air flow path 120 through the porous container 252 is deactivated (i.e., not couped to an activated air moving member) as discussed previously.

It will be appreciated that the porous container 252 may be upstream and/or downstream of a suction motor. For example, the air flow path 120 may include or be coupled to a dirty air motor upstream of the porous member 252 to drive air downstream to the porous container 252. Also, or alternatively, the air flow path 120 may include or be coupled to a clean air motor downstream of the porous member 252 to draw air downstream from the porous container 252.

### Reducing Dirt Release During Removal

In accordance with another aspect of this disclosure, dirt release during removal of a dirt collection region having a porous portion, such as a porous container 252 is provided. This aspect may be used by itself or in combination with one or more other aspect of this disclosure including the use of the air treatment unit as a surface cleaning apparatus and/or a docking station, providing the air treatment unit with an on-board power supply, emptying the air treatment unit using gravity and/or a dirt mover, accessing the refuse unit while the air treatment unit is attached, continuous operation of the air treatment unit while pneumatically isolated from the refuse unit, status-dependent operation and a variable-capacity dirt collection region, which are set out herein.

Removing a porous container may be a messy operation in which dirt (e.g., fines) passes through the pores of the porous container, e.g., as the container is closed or compressed. This may create a cloud or plume of fines adjacent a user who is removing the porous container (e.g., removing the bag to move the bag into a separate garbage disposal area).

Therefore, in accordance with this aspect, the cleaning assembly 260 includes a dampening system 261. The dampening system 261 is arranged to dampen a portion or all of the porous container 252 (e.g., part or all of the exterior surface of the porous container 252) to reduce the dispersion of dirt from the porous container 252.

As exemplified in FIGS. 12 and 13, the dampening system 261 may include one or more nozzles 263. The nozzle(s) 263 may be arranged on the air treatment unit 100 and/or the refuse unit 250. The nozzle(s) 263 are arranged to spray a liquid (e.g., a mist of water) at the porous container 252, e.g., the exterior surface of the porous container 252.

The nozzle(s) 263 may be arranged adjacent a removal opening in the refuse unit 250 through which the bag 252 is expected to be removed. The nozzle(s) 263 may be operable to spray liquid while the bag is being removed. The porous container 252 may be removed past the nozzle(s) 263 arranged near the removal opening, e.g., so that the portions of the bag 252 moving towards and/or through the removal opening may be dampened. Alternately, the spray may be applied before the porous container is moved.

The dampening system 261 includes a reservoir 265 to hold a supply of the liquid sprayed by the nozzle(s) 263. The reservoir 265 is fluidly coupled to the nozzle(s) 263 to supply the liquid.

Dampening the porous container 252 may reduce the amount of dirt dispersed from the bag 252 when the bag 252 is removed. Dampening the bag 252 may dampen the dirt to reduce dispersion and/or close or partially close the pores of the porous container 252. For example, the porous container 252 may be made of a material that expands when dampened, which may cause the pores to close or partially close. The porous container 252 may be made of, e.g., cloth or paper.

In some embodiments, the dampening system 261 functions as a seed activation system. Seeds received in the bag or built into the bag may be activated by moisture provided by the dampening system 261. For example, the cleaning assembly 260 may be used to collect compostable material containing seeds, and the dampening system 261 may be used to activate the seeds when the porous container 252 is removed from the cleaning assembly 260. The porous container 252 may be a compostable bag, such as a cloth or paper bag.

As used herein, the wording “and/or” is intended to represent an inclusive—or. That is, “X and/or Y” is intended to mean X or Y or both, for example. As a further example, “X, Y, and/or Z” is intended to mean X or Y or Z or any combination thereof.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

### Clause Set A

1. An assembly comprising:
(a) an air flow path from a dirty air inlet to a clean air outlet;
(b) a first air treatment member which is selectively connectable in air flow communication with the dirty air inlet, the first air treatment member comprising a first air treatment chamber and a first dirt collection region, the first dirt collection region having an emptying door which is operable between a closed position and an open position; and,
(c) a second air treatment member which is selectively connectable in air flow communication with the dirty air inlet, the second air treatment member comprising a second air treatment chamber and a second dirt collection region, the second collection region having an emptying door which is operable between a closed position and an open position,
wherein the assembly is operable in a first operating mode in which the first air treatment member is in air flow communication with the dirty air inlet, the emptying door of the first dirt collection region is closed, the second air treatment member is isolated from air flow communication with the dirty air inlet and the emptying door of the second dirt collection region is opened whereby dirt is emptied from the second dirt collection region, and
wherein the assembly is operable in a second operating mode in which the second air treatment member is in air flow communication with the dirty air inlet, the emptying door of the second dirt collection region is closed, the first air treatment member is isolated from air flow communication with the dirty air inlet and the emptying door of the first dirt collection region is opened whereby dirt is emptied from the first dirt collection region.

2. The assembly of clause 1 further comprising a refuse container that is removably connectable with the assembly wherein:
(a) when the refuse container is connected with the assembly, the assembly is operable in the first operating mode and the emptying door of the second dirt collection region is open, the refuse container is positioned to receive dirt from the second dirt collection region, and
(b) when the refuse container is connected with the assembly, the assembly is operable in the second operating mode and the emptying door of the first dirt collection region is open, the refuse container is positioned to receive dirt from the first dirt collection region.

3. The assembly of clause 2 wherein, during the first and second operating modes, the refuse container is isolated from the air flow path.

4. The assembly of clause 2 wherein the refuse container is made of cellulose or is a disposable bag.

5. The assembly of clause 1 further comprising a height adjustable refuse container holder which removably receives a disposable refuse container and, the height adjustable refuse container holder is removably connectable with the assembly to receive dirt collected in each of the first and second dirt collection regions when a respective emptying door is open.

6. The assembly of clause 5 wherein the disposable refuse container is a bag.

7. The assembly of clause 1 wherein the assembly comprises a docking station for a surface cleaning apparatus, the docking station comprising the dirty air inlet wherein, when a surface cleaning apparatus is docked with the assembly and the assembly is operated in the first or second operating mode, a dirt collection region of the surface cleaning apparatus is connected in air flow communication with the dirty air inlet.

8. The assembly of clause 7 wherein the docking station further comprises the clean air outlet and, when a surface cleaning apparatus is docked with the assembly and the assembly is operated in the first or second operating mode, the clean air outlet is positioned upstream of a suction motor of the surface cleaning apparatus whereby the suction motor of the surface cleaning apparatus is operable to provide air flow through the air flow path of the assembly.

9. The assembly of clause 7 wherein the docking station further comprises a charging station for the surface cleaning apparatus.

10. The assembly of clause 1 wherein the assembly comprises a lid for a garbage can and the assembly is removably positionable on the garbage can.

11. The assembly of clause 10 wherein, when the lid is positioned on the garbage can, at least a portion of the lid is pivotally openable whereby a user may dispose of waste in the garbage can when the at least a portion of the lid is pivoted to an open position.

12. The assembly of clause 1 further comprising a flexible hose that is removably connectable to the dirty air inlet whereby the assembly is operable as a vacuum cleaner when the air flow path is in communication with a suction motor.

13. The assembly of clause 12 further comprising a suction motor provided in the air flow path upstream of the clean air outlet.

14. The assembly of clause 13 wherein the assembly comprises a docking station for a surface cleaning apparatus, the docking station comprising the clean air outlet wherein, when a surface cleaning apparatus is docked with the assembly and the assembly is operated in the first or second operating mode, the clean air outlet is positioned upstream of a suction motor of the surface cleaning apparatus whereby the suction motor of the surface cleaning apparatus is operable to provide air flow through the air flow path of the assembly.

15. The assembly of clause 1 wherein the first air treatment chamber comprises a cyclone and the first dirt collection region comprises a dirt collection chamber in communication with the cyclone chamber via a cyclone chamber dirt outlet.

16. The assembly of clause 1 further comprising a first plunger which is moveable between a first position in which the first air treatment member is in air flow communication with the dirty air inlet and a second position in which the first air treatment member is isolated from air flow communication with the dirty air inlet and the emptying door of the first dirt collection region is opened whereby dirt is emptied from the first dirt collection region.

17. The assembly of clause 16 further comprising a second plunger which is moveable between a first position in which the second air treatment member is in air flow communication with the dirty air inlet and a second position in which the second air treatment member is isolated from air flow communication with the dirty air inlet and the emptying door of the second dirt collection region is opened whereby dirt is emptied from the first dirt collection region.

18. The assembly of clause 17 wherein the first and second plungers are concurrently moveable whereby the first plunger is in its first position and the second plunger is in its second position.

19. The assembly of clause 18 wherein the first and second plungers are opposed ends of a single moveable member.

### Clause Set B

1. A docking station comprising:
(a) an openable dirt collection region which, during an evacuation operation of the docking station, receives dirt that is transferred from a surface cleaning apparatus,
(b) a lock having a locked position in which the dirt collection region is secured in a closed position, and an unlocked position in which the dirt collection region is openable,
wherein, during the evacuation operation, the lock is inhibited from moving to the unlocked position.

2. The docking station of clause 1 wherein, during the evacuation operation, the dirt collection region is in air flow communication with the surface cleaning apparatus.

3. The docking station of clause 1 further comprising an evacuation actuator and an air flow path extending from a dirty air inlet to a clean air outlet wherein, during the evacuation operation, a suction motor moves air through the air flow path whereby dirt is transferred from the surface cleaning apparatus to the dirt collection region, and, when the evacuation actuator is actuated, the evacuation actuator moves the lock to the locked position.

4. The docking station of clause 3 wherein, during the evacuation operation, the evacuation actuator maintains the lock in the locked position.

5. The docking station of clause 1 wherein, during the evacuation operation, the evacuation actuator maintains the lock in the locked position.

6. The docking station of clause 1 further comprising a lid wherein the lock is operable to secure the lid in a closed position.

7. The docking station of clause 1 wherein the dirt collection region comprises a container that has an open top, the container is moveable to an open position in which the open top is accessible to receive garbage and the lock is operable to secure the container in a closed position.

8. The docking station of clause 7 wherein the container is rotatable to the open position.

9. An apparatus comprising:
(a) an air flow path extending from a dirty air inlet to a clean air outlet with a suction motor positioned in the air flow path;
(b) an openable dirt collection region into which dirt is pneumatically transferred when the suction motor is actuated,
(c) a lock having a locked position in which the dirt collection region is secured in a closed position, and an unlocked position in which the dirt collection region is openable,
wherein, during operation of the suction motor, the lock is inhibited from moving to the unlocked position.

10. The apparatus of clause 9 further comprising an actuator wherein, when the actuator is actuated, the actuator moves the lock to the locked position.

11. The apparatus of clause 10 wherein, during operation of the suction motor, the actuator maintains the lock in the locked position.

12. The apparatus of clause 9 wherein, during operation of the suction motor, the actuator maintains the lock in the locked position.

13. The apparatus of clause 9 further comprising a lid wherein the lock is operable to secure the lid in a closed position.

14. The apparatus of clause 9 wherein the dirt collection region comprises a container that has an open top, the container is moveable to an open position in which the open top is accessible to receive garbage and the lock is operable to secure the container in a closed position.

15. The apparatus of clause 14 wherein the container is rotatable to the open position.

### Clause Set C

1. An apparatus comprising:
(a) an air flow path from a dirty air inlet to a clean air outlet; and,
(b) a first air treatment member comprising a first air treatment chamber and a first dirt collection region, the first dirt collection region having an emptying door which is operable between a closed position and an open position,
wherein the apparatus is operable in a first operating mode in which the first air treatment member is in air flow communication with the dirty air inlet and the emptying door of the first dirt collection region is closed, and
wherein the apparatus is operable in a second operating mode in which air flow through the first air treatment member is terminated and the emptying door of the first dirt collection region is open whereby dirt is transferable to a refuse container.

2. The apparatus of clause 1 wherein, during the first operating mode, the refuse container is isolated from the air flow path.

3. The apparatus of clause 1 wherein, when the apparatus is positioned on the refuse container, at least a portion of the apparatus is pivotally openable whereby a user may dispose of waste in the refuse container when the at least a portion of the apparatus is pivoted to an open position.

4. The apparatus of clause 1 further comprising a housing and the housing is openable whereby the refuse container is accessible.

5. The apparatus of clause 4 wherein, when the housing is open, the refuse container is removable whereby the refuse container is emptyable.

6. The apparatus of clause 4 wherein, when the housing is open, a disposable bag is removable positionable in the refuse container.

7. The apparatus of clause 4 wherein the first air treatment member and the first dirt collection region comprise an upper portion of the housing.

8. The apparatus of clause 7 wherein the first air treatment member and the first dirt collection region comprise a lid of the housing.

9. The apparatus of clause 1 further comprising a flexible hose that is removably connectable to the dirty air inlet whereby the apparatus is operable as a vacuum cleaner when the air flow path is in communication with a suction motor.

10. The apparatus of clause 1 wherein the apparatus comprises a docking station for a surface cleaning apparatus, the docking station comprising the dirty air inlet wherein, when a surface cleaning apparatus is docked with the apparatus and the apparatus is operated in the first operating mode, a dirt collection region of the surface cleaning apparatus is connected in air flow communication with the dirty air inlet.

11. The apparatus of clause 1 further comprising a suction motor provided in the air flow path upstream of the clean air outlet.

12. The apparatus of clause 1 wherein the apparatus comprises a docking station for a surface cleaning apparatus, the docking station comprising the clean air outlet wherein, when a surface cleaning apparatus is docked with the assembly and the assembly is operated in the first operating mode, the clean air outlet is positioned upstream of a suction motor of the surface cleaning apparatus whereby the suction motor of the surface cleaning apparatus is operable to provide air flow through the air flow path of the assembly.

13. The apparatus of clause 1 wherein the apparatus comprises a lid that is positionable on the refuse container.

14. The apparatus of clause 7 wherein the apparatus is operable in the second mode of operation when the lid is positioned on the refuse container.

15. The apparatus of clause 8 wherein the apparatus is operable in the first mode of operation when the lid is positioned on the refuse container.

### Clause Set D

1. An apparatus comprising:
(a) an air flow path from a dirty air inlet to a clean air outlet;
(b) a refuse container positioned in the air flow path wherein at least a portion of the refuse container is porous; and,
(c) a second stage air treatment chamber downstream of the refuse container and upstream of the clean air outlet,
wherein, in operation, air enters the dirty air inlet and passes through the refuse container to the second air treatment chamber.

2. The apparatus of clause 1 wherein the second stage air treatment chamber comprises a cyclone assembly comprising a cyclone.

3. The apparatus of clause 1 wherein dirt collected in the second stage air treatment chamber is emptied into the refuse container.

4. The apparatus of clause 1 wherein dirt collected in the second stage air treatment chamber is emptied into the refuse container when the refuse container is at atmospheric pressure.

5. The apparatus of clause 2 wherein dirt collected in the cyclone assembly is emptied into the refuse container.

6. The apparatus of clause 2 wherein dirt collected in the cyclone assembly is emptied into the refuse container when the refuse container is at atmospheric pressure.

7. The apparatus of clause 6 wherein the cyclone assembly has a dirt collection region having an openable door and the dirt collection region is positioned above a lower end of the refuse container.

8. The apparatus of clause 1 wherein the refuse container is made of a porous material.

9. The apparatus of clause 1 wherein at least two spaced apart portions of the refuse container are made of a porous material.

10. The apparatus of clause 1 further comprising a motor and fan assembly which, when energized, produces an air flow that enters the dirty air inlet.

11. The apparatus of clause 1 wherein a dirt collection region of a surface cleaning apparatus is dockable with the apparatus and, in operation, air travels from the dirt collection region, enters the dirty air inlet and passes through the refuse container to the second air treatment chamber.

12. An apparatus comprising:
(a) an air flow path from a dirty air inlet to a clean air outlet;
(b) a refuse container positioned in the air flow path wherein at least a portion of the refuse container is porous; and,
(c) a second air treatment stage downstream of the refuse container and upstream of the clean air outlet, wherein dirt collected in the second air treatment stage is emptied into the refuse container,
wherein, in operation, air enters the dirty air inlet and passes through the refuse container to the second air treatment stage.

13. The apparatus of clause 12 wherein dirt collected in the second air treatment stage is emptied into the refuse container.

14. The apparatus of clause 12 wherein the second air treatment stage has a dirt collection region having an openable door and the dirt collection region is positioned above a lower end of the refuse container.

15. The apparatus of clause 12 wherein dirt collected in the second air treatment stage is emptied into the refuse container when the refuse container is at atmospheric pressure.

16. The apparatus of clause 15 wherein the second air treatment stage has a dirt collection region having an openable door and the dirt collection region is positioned above a lower end of the refuse container.

17. The apparatus of clause 13 wherein the second air treatment stage comprises a cyclone assembly comprising a cyclone and a dirt collection region, and the dirt collection region is emptied into the refuse container.

18. The apparatus of clause 12 wherein the refuse container is made of a porous material.

19. The apparatus of clause 12 wherein at least two spaced apart portions of the refuse container are made of a porous material.

### Clause Set E

1. An apparatus comprising:
(a) a surface cleaning apparatus comprising:
(i) an air flow path from a dirty air inlet to a clean air outlet; and,
(ii) an air treatment member comprising an air treatment chamber and a dirt collection region; and,
(b) a refuse unit comprising a refuse container, wherein the refuse unit is adjustable whereby a volume of the refuse container is variable,
wherein the surface cleaning apparatus is operable in a surface cleaning operating mode in which the surface cleaning apparatus is used to clean a surface whereby dirt is collected in the dirt collection region, and
wherein the air treatment unit is operable in an emptying mode in which the surface cleaning apparatus is docked with the refuse unit and dirt is transferred to the refuse container.

2. The apparatus of clause 1 wherein the refuse unit comprise a support frame for the refuse container and a size of the refuse unit is adjustable.

3. The apparatus of clause 2 wherein the refuse container is flexible.

4. The apparatus of clause 3 wherein the refuse container has an adjustable length.

5. The apparatus of clause 4 wherein the refuse container comprises a continuous tube of flexible material.

6. The apparatus of clause 1 wherein the refuse unit comprise a support frame for the refuse container and a height of the refuse unit is adjustable.

7. The apparatus of clause 2 wherein, during the emptying mode, the refuse container is at atmospheric pressure.

8. The apparatus of clause 2 wherein the refuse container is disposable, and the refuse container is removably mountable to the support frame.

9. The apparatus of clause 2 wherein the refuse container is biodegradable, and the refuse container is removably mountable to the support frame.

10. The apparatus of clause 1 wherein the refuse container comprises a plurality of telescoping segments.

11. The apparatus of clause 10 wherein the telescoping segments are rigid.

12. The apparatus of clause 10 wherein, during the emptying mode, the refuse container is at atmospheric pressure.

13. The apparatus of clause 1 wherein, during the emptying mode, the refuse container is at atmospheric pressure.

14. The apparatus of clause 1 wherein the surface cleaning apparatus has an on board energy storage member that is rechargeable when the surface cleaning apparatus is docked with the refuse unit.

15. The apparatus of clause 1 further comprising a first hose which is attachable to the dirty air inlet of the surface cleaning apparatus and is useable while the surface cleaning apparatus is docked with the refuse unit.

16. The apparatus of clause 15 further comprising a second hose which is attachable to the dirty air inlet of the surface cleaning apparatus and is useable while the surface cleaning apparatus is removed from the refuse unit wherein the second hose is shorter than the first hose.

Clause Set F

1. An assembly comprising:
(a) an air flow path from a dirty air inlet to a clean air outlet;
(b) an air treatment member which is selectively connectable in air flow communication with the dirty air inlet, the air treatment member comprising an air treatment chamber and a dirt collection region, the dirt collection region having an emptying door which is operable between a closed position and an open position; and,
(c) a plunger which is moveable between a first position in which the air treatment member is in air flow communication with the dirty air inlet and a second position in which the air treatment member is isolated from air flow communication with the dirty air inlet and the emptying door of the dirt collection region is opened whereby dirt is emptied from the first dirt collection region,
wherein the assembly is operable in a first operating mode in which the air treatment member is in air flow communication with the dirty air inlet and the emptying door of the dirt collection region is closed, and
wherein the assembly is operable in a second operating mode in which the air treatment member is isolated from air flow communication with the dirty air inlet and the emptying door of the dirt collection region is opened whereby dirt is emptied from the dirt collection region.

2. The assembly of clause 1 wherein the air treatment chamber comprises a longitudinally extending open volume having a longitudinally extending sidewall and at least a portion of the sidewall is porous.

3. The assembly of clause 2 wherein the portion of the sidewall that is porous comprises a screen.

4. The assembly of clause 2 wherein the plunger is longitudinally slideable into the open volume.

5. The assembly of clause 2 wherein the emptying door moves to an open position as the plunger moves from the first position to the second position.

6. The assembly of clause 2 wherein movement of the plunger from the first position to the second position drives the emptying door to an open position.

7. The assembly of clause 6 wherein the movement of the plunger from the first position to the second position mechanically drives the emptying door to the open position.

1. A first surface cleaning apparatus comprising:
(a) an air treatment unit comprising:
(i) a first air flow path from a first dirty air inlet to a clean air outlet; and,
(ii) a first air treatment member comprising a first air treatment chamber and a first dirt collection region, the first dirt collection region having an emptying door which is operable between a closed position and an open position,
(b) a refuse unit comprising a refuse container; and,
(c) a flexible hose that is removably connectable to the dirty air inlet,
wherein the air treatment unit is operable in a first operating mode in which the first air treatment member is in air flow communication with the dirty air inlet and the emptying door of the first dirt collection region is closed, and
wherein the air treatment unit is operable in a second operating mode in which air flow through the first air treatment member is terminated and the emptying door of the first dirt collection region is open whereby dirt is transferable to the refuse container while the refuse container is at atmospheric pressure.

2. The first surface cleaning apparatus of claim 1 wherein, during the first operating mode, the refuse container is isolated from the first air flow path.

3. The first surface cleaning apparatus of claim 1 wherein the air treatment unit further comprises a second air treatment member which is selectively connectable in air flow communication with the dirty air inlet, the second air treatment member comprising a second air treatment chamber and a second dirt collection region, the second dirt collection region having an emptying door which is operable between a closed position and an open position,
wherein, in the first operating mode, the second air treatment member is isolated from air flow communication with the dirty air inlet and the emptying door of the second dirt collection region is openable whereby dirt is transferable to the refuse container while the refuse container is at atmospheric pressure, and
wherein, in the second operating mode, the second air treatment member is in air flow communication with the dirty air inlet and the emptying door of the second dirt collection region is closed.

4. The first surface cleaning apparatus of claim 3 wherein, during the first and second operating modes, the refuse container is isolated from the first air flow path.

5. The first surface cleaning apparatus of claim 1 wherein the refuse container is made of cellulose or is a disposable bag.

6. The first surface cleaning apparatus of claim 1 wherein the refuse container is disposable, and the surface cleaning apparatus further comprises a height adjustable refuse container holder which removably receives the disposable refuse container.

7. The first surface cleaning apparatus of claim 6 wherein the height adjustable refuse container holder is removably connectable with the air treatment unit.

8. The first surface cleaning apparatus of claim 1 wherein the disposable refuse container is a bag.

9. The first surface cleaning apparatus of claim 1 wherein the first surface cleaning apparatus comprises a docking station for a second surface cleaning apparatus, the docking station comprising a second dirty air inlet wherein, when the second surface cleaning apparatus is docked with the first surface cleaning apparatus and the first surface cleaning apparatus is operated in the first operating mode, a dirt collection region of the second surface cleaning apparatus is connected in air flow communication with the second dirty air inlet and a second air flow path connects the second dirty air inlet in fluid communication with the first air treatment member.

10. The first surface cleaning apparatus of claim 9 wherein the docking station further comprises the clean air outlet and, when the second surface cleaning apparatus is docked with the first surface cleaning apparatus and the first surface cleaning apparatus is operated in the first operating mode, the clean air outlet is positioned upstream of a suction motor of the second surface cleaning apparatus whereby the suction motor of the second surface cleaning apparatus is operable to provide air flow through the air flow path of the first surface cleaning apparatus.

11. The first surface cleaning apparatus of claim 9 wherein the docking station further comprises a charging station for the surface cleaning apparatus.

12. The first surface cleaning apparatus of claim 1 further comprising a suction motor provided in the first air flow path upstream of the clean air outlet.

13. The first surface cleaning apparatus of claim 1 wherein the first air treatment chamber comprises a cyclone and the first dirt collection region comprises a dirt collection chamber in communication with the cyclone chamber via a cyclone chamber dirt outlet.

14. The first surface cleaning apparatus of claim 1 wherein the first surface cleaning apparatus is operable as a vacuum cleaner and as a docking station for a second surface cleaning apparatus.

15. An apparatus comprising:
(a) a surface cleaning apparatus comprising:
(i) a first air flow path from a first dirty air inlet to a clean air outlet; and,
(ii) a first air treatment member comprising a first air treatment chamber and a first dirt collection region, the first dirt collection region having an emptying door which is operable between a closed position and an open position; and,
(b) a refuse unit comprising a refuse container,
wherein the surface cleaning apparatus is operable in a first surface cleaning operating mode in which the emptying door of the first dirt collection region is closed, and the surface cleaning apparatus is used to clean a surface whereby dirt is collected in the first dirt collection region, and
wherein the air treatment unit is operable in an emptying mode in which the surface cleaning apparatus is positioned on the refuse unit and closes an open end of the refuse unit, air flow through the first air treatment member is terminated and the emptying door of the first dirt collection region is open whereby dirt is transferable to the refuse container while the refuse container is at atmospheric pressure.

16. The apparatus of claim 15 wherein, during the surface cleaning operating mode, a suction motor of the surface cleaning apparatus is deenergized.

17. The apparatus of claim 15 wherein the surface cleaning apparatus further comprises a second air treatment member which is selectively connectable in air flow communication with the dirty air inlet, the second air treatment member comprising a second air treatment chamber and a second dirt collection region, the second dirt collection region having an emptying door which is operable between a closed position and an open position,
wherein, in the first surface cleaning operating mode, the second air treatment member is isolated from air flow communication with the dirty air inlet and the emptying door of the second dirt collection region is openable whereby dirt is transferable to the refuse container while the refuse container is at atmospheric pressure, and
wherein, in the second surface cleaning operating mode, the second air treatment member is in air flow communication with the dirty air inlet and the emptying door of the second dirt collection region is closed.

18. The apparatus of claim 17 wherein in the second surface cleaning operating mode, the apparatus is operable in the emptying mode.

19. The apparatus of claim 15 wherein the surface cleaning apparatus is operable in the first surface cleaning operating mode while the surface cleaning apparatus is removed from the refuse unit.

20. The apparatus of claim 17 wherein the surface cleaning apparatus is operable in the first surface cleaning operating mode and on the second surface cleaning mode while the surface cleaning apparatus is removed from the refuse unit.
